(19) United States
(12) Patent Application Publication
(10) Pub. No.: US 2013/0095508 A1
(43) Pub. Date: Apr. 18, 2013

(54) INSTRUMENTED PIPETTE

(71) Applicants: Andrew Paul Campitelli, Carnegie (AU); Erol Craig Harvey, Ringwood (AU); John Edward McCormack, Clifton Hill (AU); Matthew Daniel Solomon, Hughesdale (AU); Edward Francis Wilkinson, Deepdene (AU); Michael William Wilkinson, Deepdene (AU); Grit Diessner, Brunswick (AU)

(72) Inventors: Andrew Paul Campitelli, Carnegie (AU); Erol Craig Harvey, Ringwood (AU); John Edward McCormack, Clifton Hill (AU); Matthias Schuenemann, Brunswick (AU); Matthew Daniel Solomon, Hughesdale (AU); Edward Francis Wilkinson, Deepdene (AU); Michael William Wilkinson, Deepdene (AU)

(73) Assignee: MINIFAB (AUSTRALIA) PTY LTD, Scoresby Victoria (AU)

(21) Appl. No.: 13/496,840

(22) PCT Filed: Sep. 17, 2010
(86) PCT No.: PCT/AU2010/001220

§ 371 Date: Dec. 12, 2012

Related U.S. Application Data
(60) Provisional application No. 61/243,904, filed on Sep. 18, 2009.

(51) Int. Cl. B01L 3/02; G01N 21/00; G01N 27/00

(52) U.S. Cl. CPC B01L 3/021; G01N 27/00; G01N 21/00; B01L 3/0217
USPC 435/7.94; 422/525; 422/502; 422/82.01; 422/82.05; 422/522; 422/544; 435/7.92; 436/149; 436/164; 436/501; 435/287.2; 422/514

(57) ABSTRACT

A pipette component for use in performing an experimental procedure with a fluid sample and a pipette, the pipette component including: a pipette interface configured to engage sealingly and separably with a body of the pipette; a tip interface configured to engage sealingly and separably with a replaceable tip; and an experiment region configured to receive at least part of the fluid sample by operation of the pipette, and configured to perform at least part of the experimental procedure in the experiment region using the at least part of the fluid sample.

### FIELD

The present invention relates to methods, apparatus and components for use in performing an experimental procedure with a fluid sample and a pipette.

### BACKGROUND

A pipette is a laboratory (or ‘lab’) instrument that may be used to measure, transport and manipulate fluids. Pipettes can also be referred to as pipets, pipettors or droppers.

A pipette can draw fluid through a tip into its chamber (the drawing step) and subsequently dispense the fluid from the chamber (the dispensing step). A plunger attached to the pipette provides suction to draw the fluid(s) in, and pressure to dispense the fluid(s). Pipette can be hand-held and manually operated by a person, or they can be laboratory or industrial machines operated by a robot. The person or robot operating the pipette is referred to as a user or operator.

Pipettes, and in particular micropipettes, are commonly used in the fields of chemistry, molecular biology, medical diagnostics and other analytical sciences. In these fields, various fluids (including liquids, mixtures, eta) including specimens, reagents and reactants can be accurately measured and mixed using a pipette. Pipettes can also be used to carry or transport products of reactions to detection unit(s) for analysis.

Pipettes commonly have replaceable and disposable tips. For example, commercially available laboratory pipettes are often available with sets of replacement tips: each tip can be used for measuring one fluid, and then discarded. Replaceable and disposable pipette tips are generally configured to fit securely onto the pipette, e.g., the tip can be made of a resiliently deformable material (e.g., polypropylene) that stretches slightly to fit over the connecting end of the pipette's body. The disposable tips can be ejected from the pipette using an ejector on the pipette, which allows for rapid replacement of the disposable tips and avoids any contact between a used tip and the operator's hands (or other tools). Pipettes with replaceable tips are particularly suitable when working with different fluid samples that can cross-contaminate one another, particularly when there is a possibility of cross contamination between different fluids used in the one experimental procedure. By using a pipette, an operator's hands do not touch the fluids, and a fresh disposable tip can be used for each step or fluid in an analytical procedure.

For an experimental procedure to have a high degree of precision, it is generally necessary to strictly adhere to experimental protocols that stipulate the order in which reagents are added and the quantities of the reagents. Experimental procedures that rely on pipette use are, however, susceptible to operator errors caused by poor adherence to protocols. For example, piston-driven air displacement pipettes are used in many experimental and analytic applications, but are subject to inaccuracies due to poor operator technique. Accordingly, discrepancies are often found between results of experiments carried out by different operators, and this reduces confidence in results obtained using manually operated pipettes. The consequences of operator error are compounded by the fact that in some technical fields specimens often only exist in very small quantities, thus any error that compromises results may result in new specimens having to be harvested or acquired at potentially great expense and inconvenience. To mitigate susceptibility to operator error, pipettes have been developed that automate the sample drawing and dispensing steps. For example, digital inputs and displays have been added to pipettes to reduce errors caused by inaccurate volume readings. Despite these measures, there is still a significant risk that an operator (e.g., due to fatigue) will operate a pipette incorrectly (e.g., by dispensing an incorrect volume), or fail to follow protocols, or even miss a step in a procedure.

Certain experimental procedures require the use of materials that are sensitive to degradation or contamination when exposed to the lab environment (e.g., room air). For materials that are used in many experiments, degradation and contamination may change their properties sufficiently to ruin, or at least compromise, the outcomes of some of the experiments. For example, lyophilised reagents draw moisture from the air in the lab, and thus become compromised: it may be impossible to reconstitute them for use in experiments. Similarly, biological materials and chemical reactants may become contaminated by lab air, or by contaminants transferred unintentionally by lab apparatus (e.g., through operator error).

Many experimental procedures require the use of auxiliary detection units such as potentiometers, chromatographs, spectrofluorometers and mass spectrometers. These units may be expensive and/or limited in the scope of specimens they detect. Use of these units generally increases the complexity of experimental procedures and protocols, the time and movement required for the experimental procedure (by the operator), and the susceptibility to cross contamination and operator error.

It is desired to address or ameliorate one or more disadvantages or limitations associated with the prior art, or to at least provide a useful alternative.

### SUMMARY

In accordance with the present invention, there is provided a pipette component for use in performing an experimental procedure with a fluid sample and a pipette, the pipette component including:
a pipette interface configured to engage sealingly and separably with a body of the pipette;
a tip interface configured to engage sealingly and separably with a replaceable tip; and
an experiment region configured to receive at least part of the fluid sample by operation of the pipette, and configured to perform at least part of the experimental procedure in the experiment region using the at least part of the fluid sample.

The present invention also provides a method of performing an experimental procedure with a fluid sample and a pipette including:
fitting a pipette component to the pipette;
fitting a replaceable tip to the pipette component;
drawing at least part of the fluid sample into the pipette component by operating the pipette; and
performing at least part of the experimental procedure in the pipette component using the at least part of the fluid sample.

The present invention also provides a pipette component for use in performing an experimental procedure with a fluid sample and a pipette, the pipette component including:
a pipette interface configured to engage sealingly and separably with a body of the pipette;
a stored substance for use in the experimental procedure; and
an experiment region configured to receive at least part of the fluid sample by operation of the pipette, and configured to perform at least part of the experimental procedure using the stored substance and the fluid sample in the experiment region.

The present invention also provides a method of performing an experimental procedure with a fluid sample and a pipette including:
fitting a pipette component to the pipette;
drawing at least part of the fluid sample into the pipette component by operating the pipette; and
performing at least part of the experimental procedure using at least one stored substance in the pipette component and the at least part of the fluid sample.

The present invention also provides a pipette component for use in performing an experimental procedure with a fluid sample and a pipette, the pipette component including:
a pipette interface configured to engage sealingly and separably with a body of the pipette;
an experiment region configured to receive at least part of the fluid sample by operation of the pipette, and configured to perform at least part of the experimental procedure in the experiment region using the at least part of the fluid sample to generate one or more measurement signals;
a transmitter configured to receive the measurement signals, and to transmit corresponding signals to an external receiver system.

The present invention also provides a method of performing an experimental procedure with a fluid sample and a pipette including:
fitting a pipette component to the pipette;
drawing at least part of the fluid sample into the pipette component by operating the pipette;
performing at least part of the experimental procedure using at least part of the fluid sample in the pipette component, including generating one or more measurement signals by measuring a sample property in the experimental procedure; and
transmitting signals corresponding the measurement signals using a transmitter in the experimental component to an external receiver system.

The present invention also provides an adapter for use in performing an experimental procedure with a fluid sample and a pipette, the adapter including:
a pipette interface configured to fit sealingly and separably to a body of the pipette;
a tip interface configured to receive a replaceable tip associated with the pipette; and
an experiment region configured to receive at least part of the fluid sample by operation of the pipette.

The described replaceable tip can be one of a plurality of pipette tips associated with the pipette.

The described pipette component for performing an experimental procedure with a pipette can include:
a pipette interface configured to engage separably with the pipette's body, such that actuation of the pipette draws a fluid sample into the pipette component;
an experiment region configured to perform the experimental procedure on the fluid sample in the pipette component; and
a tip interface configured to engage separably with a tip component associated with the pipette.

The pipette can include a plurality of ejectors for ejecting the tip component and separately ejecting the pipette component from the pipette.

The described pipette component for performing an experimental procedure with a pipette can include:
a pipette interface configured to engage separably with a pipette body, such that actuation of the pipette draws a fluid sample into the pipette component; and
an experiment region configured to perform the experimental procedure on the fluid sample in the pipette component, including one or more microfluidic structures used in at least part of the experimental procedure.

The pipette component can include one or more optical or electronic structures for measuring or stimulating the fluid sample to perform the experimental procedure. The electronic structures can include a communications structure, e.g., wireless electronics including an antenna, for sending a measurement signal representing measurements made in the experiment region.

The described system can include the pipette component and an external receiver for receiving the measurement signal from the pipette component.

The described pipette component for performing an experimental procedure with a pipette can include:
a pipette interface configured to engage separably with the pipette's body, such that actuation of the pipette draws a fluid sample into the pipette component; and
an experiment region configured to perform the experimental procedure on the fluid sample in the pipette component, including at least one stored substance used in at least part of the experimental procedure.

The at least one embedded substance can be a lyophilised reagent stored in the experiment region, and/or a functionalised surface layer formed on a sensing surface of the experiment region.

The described instrumented pipette can include the pipette and the pipette component.

The described method for performing an experimental procedure with a pipette can include:
engaging a pipette component with the pipette;
engaging a tip component with the pipette component;
drawing a fluid sample into the pipette component using the pipette; and
performing the experimental procedure using the pipette component.

The described method for performing an experimental procedure with a pipette can include:
engaging a pipette component with the pipette;
drawing a fluid sample into the pipette component using the pipette; and
performing the experimental procedure using the pipette component, including using one or more microfluidic structures of the pipette component.

The described method for performing an experimental procedure with a pipette can include:
engaging a pipette component with the pipette;
drawing a fluid sample into the pipette component using the pipette; and
performing the experimental procedure using the pipette component, including using at least one stored substance of the pipette component.

The described pipette component for performing an experimental procedure on a fluid sample with a pipette can include:
a housing including:
   at least one fluid reservoir configured to hold the fluid sample during the experimental procedure, and
   one or more experimental structures used in the experimental procedure;
a pipette interface configured to engage separably with a shaft of the pipette; and
a tip interface configured to engage separably with a disposable tip associated with the pipette.

The experimental structures can include fluidic/microfluidic structures, electronic/microelectronic structures and optical/photonic structures.

The described instrumented pipette can include:
a handle for actuating the pipette to draw in a fluid sample;
a shaft extending from the handle;
a disposable tip associated with the pipette through which the fluid sample is drawn by actuating the handle; and
a pipette component for performing an experimental procedure on the fluid sample, including:
   a housing including:
      at least one fluid reservoir configured to hold the fluid sample during the experimental procedure; and
      one or more experimental structures used in the experimental procedure,
   a pipette interface configured to engage separably with the shaft of the pipette, and
   a tip interface configured to engage separably with the disposable tip.

The described pipette system can include:
an instrumented pipette, including:
   a handle for actuating the pipette to draw in a fluid sample,
   a shaft extending from the handle,
   a disposable tip associated with the pipette through which the fluid sample is drawn by actuating the handle, and
   a pipette component for performing an experimental procedure on the fluid sample, including:
      a housing including:
         at least one fluid reservoir configured to hold the fluid sample during the experimental procedure, and
         one or more experimental structures used in the experimental procedure, including a communications structure for sending a measurement signal representing measurements made in the experimental procedure;
      a pipette interface configured to engage separably with the shaft of the pipette; and
      a tip interface configured to engage separably with the disposable tip, and
   the disposable tip associated with the pipette through which the fluid sample is drawn by actuating the handle; and
an external receiver for receiving the measurement signal from the pipette component.

### BRIEF DESCRIPTION OF THE DRAWINGS

Preferred embodiments of the present invention are hereinafter further described, by way of example only, with reference to the accompanying drawings, in which:

FIG. 1 is a sketch of an exploded view of an instrumented pipette;

FIG. 2 is a sketch of a pipette system, including the instrumented pipette;

FIG. 3 is a sketch of internal components of the instrumented pipette;

FIG. 4 is a sketch of a front view of an experimental component of the instrumented pipette;

FIG. 5 is a sketch of a side view of the experimental component;

FIG. 6 is a flow chart of a simple experimental method using the instrumented pipette;

FIG. 7 is a flow chart of a general experimental method using the instrumented pipette;

FIG. 8 is a sketch of the instrumented pipette showing ejectors;

FIG. 9 is a sketch of the instrumented pipette with the experimental component and a disposable tip in an assembled state;

FIG. 10 is a sketch of the instrumented pipette with the disposable tip in an ejected state;

FIG. 11 is a sketch of the instrumented pipette with the experimental component in an ejected state;

FIG. 12 is a schematic sketch showing the experimental component with a wireless transceiver;

FIG. 13 is a sketch of the pipette system with an external experimental unit;

FIG. 14 is a schematic sketch of a competitive enzyme-linked immunosorbent assay (ELISA) chip of the experimental component;

FIG. 15 is a schematic sketch of a sandwich ELISA chip of the experimental component;

FIGS. 16A and 16B are schematic sketches of cross-sectional views of embodiments of the instrumented pipette and the experimental component including example optical systems; and

FIGS. 17A, 17B, 17C and 17D are schematic sketches of cross-sectional views of an embodiment of the experimental component including a sliding ejector.

### DETAILED DESCRIPTION

### Overview

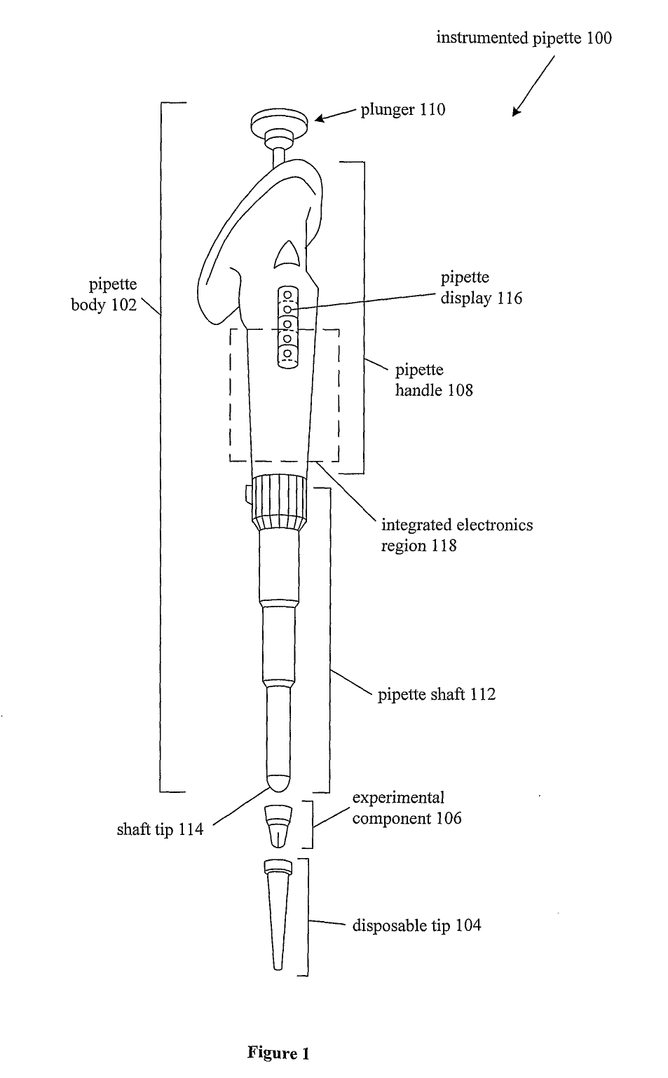

An instrumented pipette 100, as shown in FIG. 1, includes a pipette body 102 and an experimental component 106 configured to attach to the pipette body 102. The pipette body 102 can be a commercially available pipette body. The experimental component 106 is a pipette component for performing an experimental procedure (or following an experimental protocol). The pipette component can be referred to as a pipette attachment, a disposable tip attachment, a pipette apparatus, an adapter (e.g., for adapting between a standard pipette and a removable/replaceable tip associated with the pipette), an instrumented tip, or a functionalised tip. The experimental component 106 includes a pipette interface (also referred to as a pipette-engaging portion) that is configured to engage separably and sealingly with the pipette body 102 such that operation of a suction/pressure device of the pipette (e.g., a plunger 110) draws fluid into the experimental component 106. The pipette interface fits the experimental component 106 to the pipette body 102 and is substantially sealed to air and the fluid. For example, the experimental component 106 can engage or couple by means of a press fit (or interference fit) around a shaft of the pipette body 102, or by means of a screw threaded fitting that screws into or onto the pipette body 102.

The experimental component 106 includes an experiment region 401 for use in performing the experimental procedure using the fluid sample in contact with, inside or on the experimental component 106.

The experimental component 106 can be used with a replaceable and disposable pipette tip 104 associated with the pipette (e.g., one of a plurality of replaceable tips configured to fit to a pipette body even without the experimental component 106 for use in normal pipetting). The disposable tip 104 engages separably and sealingly with the instrumented pipette 100. In some embodiments, the disposable tip 104 engages directly with the experimental component 106 (and thus indirectly with the pipette body 102), and the experimental component 106 includes a tip interface (also referred to as a tip-engaging portion) configured to engage separably and sealingly with the disposable tip 104. In other embodiments the disposable tip 104 engages directly with the pipette body 102 over the experimental component 106. The disposable tip 104 engages with the tip interface by means of a press fit (or interference fit) that is substantially sealed to air and the fluid. The disposable tip 104 is typically manufactured and sized in association with the pipette body 102 and can be a commercially available disposable tip. The pipette interface can include a generally circular socket including elastic material configured to engage around a distal end of the shaft of the body of the pipette. The distal end is distal from the body, or handle end, of the pipette.

In use, at least part of a fluid sample is drawn into the tip 104 by operating the pipette body 102: the experiment region 401 extends into the tip 104 and into the fluid in the tip 104: the experiment region 401 can be described as being fitted into the fluid-receiving tip 104. At least a portion of the experimental component 106 is in contact with the fluid, thus the fluid sample contacts/touches the experiment region 401.

The experimental component 106 provides a form of “laboratory on a chip” (or “lab on a chip”) that uses the pumping structures in the pipette body 102 (i.e., the vacuum and air pressure controller) to move sample fluids into, around, and from the chip. The experiment region 401 refers to a region of the experimental component 106 configured to perform at least part of the experimental procedure. The experimental procedure can be a procedure for detecting/measuring substances, testing/trialling substances or a routine bio/chemical procedure as performed in a laboratory or industrial setting. The experimental component 106 uses microfluidics, optics, electronics, and/or one or more stored substances (e.g., biochemical compounds and/or reagents) in performing at least part of the experimental procedure. The experiment region 401 can include at least one microfluidic structure configured to perform at least part of the experimental procedure, e.g., the experiment region can include a chamber configured to receive and hold at least part of the fluid sample in part of the experimental procedure. The microfluidic structures can include any combination of the following: sensors; filters; separators; mixers; reactant/reagent storage; and fluid control means, such as valves and hydrophobic vents. The experiment region 401 can include one or more optical components and microelectronic components used in the experimental procedure. The experiment region 401 can include at least one stored or embedded substance, such as a reagent or bio-molecule, used in at least part of the experimental procedure. The stored substances can also be referred to as in-build or embedded substances as they are incorporated into the structures of the experimental component 106. The experiment region 401 can include a fluidic mixing structure configured to cause at least part of the fluid sample to mix with the stored substance in the experimental procedure.

The experiment region 401 may include: a sensor region for experimental procedures including detection, sensing, measurement, etc.; and/or an active region for experimental procedures including reactants, heating/cooling, transforming, charging, irradiating, etc. The experiment region 401 can include at least one sensor configured to generate measurement signals by measuring a sample property in or during the experimental procedure. The at least one sensor can be electrical, electrochemical and/or optical for measuring at least one respective electrical, electrochemical and/or optical property of the at least part of the fluid sample in the experimental procedure.

The experiment region 401 can include one or more active subregions. The active subregions are configured to perform parts of the experimental procedure that operate on the fluid sample to generate a new fluid sample (e.g., by stimulating a reaction or a response in the fluid sample). The fluid sample and the new fluid sample have differing properties, e.g., being respectively reactants and products of a bio/chemical reaction. The active regions can perform steps associated with sample preparation of the fluid sample for a subsequent experimental procedure, either in the pipette component or in an external laboratory apparatus. For example the experimental component 106 may be configured to: use an electrical current (e.g., in a form of capillary electrophoresis sensor); heat the fluid sample; cool the fluid sample; and/or mix a reactant (e.g., a lyophilised reagent) stored in the pipette component with the fluid sample.

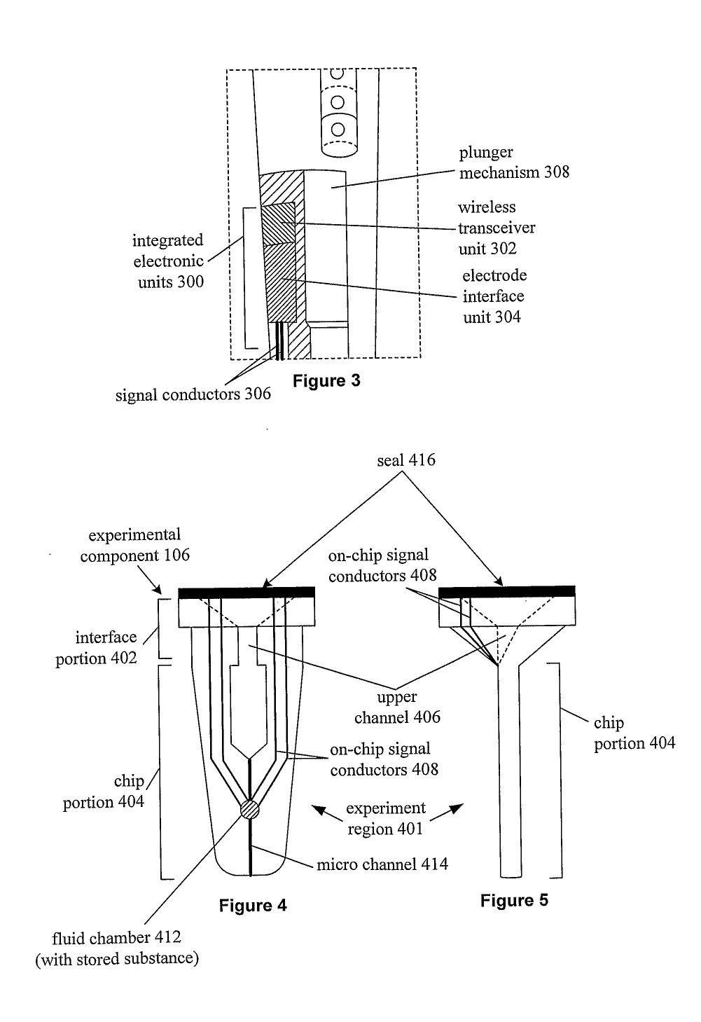

The experiment region 401 can include one or more passive subregions. The passive subregions are configured to perform parts of the experimental procedure that detect or measure at least one property of the fluid sample, and generate a measurement signal representative of the property, without substantially changing the fluid. The passive subregions can include a communications transceiver with a wired or wireless connection, such as an electrical port or an antenna (e.g., a radio-frequency (RF) antenna), configured to send the signal to an external receiving station. The external receiving station may be in an apparatus external to the instrumented pipette 100, or may be in the pipette body 102 (e.g., included in a wireless transceiver unit 302 described below with reference to FIG. 3).

The experimental component 106 can include a power receiver for receiving electrical power for use in the experimental procedure, e.g., from an external power transmitter. The power receiver can be wired, including an electrical conductor connecting to a power plug/socket, or wireless, based on an induction loop. The power receiver may receive power directly from the external power transmitter, or from a power source in the pipette body 102. The power receiver may charge an internal battery, e.g., in the pipette body 102, which provides the electrical power for use in the experimental procedure.

The experimental procedure can be performed also using an external apparatus, such as a reading station (e.g., with an electrical probe or an optical probe). The experimental component 106 can include a transmitter (e.g., including en electronic amplifier, and an antenna or optical emitter for wireless communication) configured to receive the measurement signals from the sensor structures, and to transmit corresponding signals to a reading station, or external receiver system. The external apparatus can include at least one of: an inductive loop for transmitting electrical power to the experimental component 106, via a power receiver in the experimental component; an antenna for receiving radio-frequency (RF) measurement signals wirelessly from the experimental component; and an optical detector for receiving optical signals from the experimental component.

The pipette body 102 can have the form of a typical laboratory pipette with a pipette handle 108 configured for holding in a person's hand, e.g., as in a standard commercially available hand-held manually operated pipette. The plunger 110 is configured to draw fluid into the instrumented pipette 100 and eject, or dispense, the received fluid from the instrumented pipette 100. A pipette shaft 112 with a shaft tip 114 is configured to receive the experimental component 106 and/or the disposable tip 104. A pipette display 116 on the pipette body 102 displays information to the user about the instrumented pipette 100 and a received fluid sample, such as the volume of sample drawn up or dispensed by a single operation of the plunger 110, or information from the experimental component 106. The instrumented pipette 100 includes an integrated electronics region 118 where in some embodiments integrated electronics are held in the pipette body 102. In other embodiments the instrumented pipette 100 does not include the integrated electronics region 118 or the integrated electronics, and is used primarily for pumping (drawing in and dispensing) the fluid sample.

Alternatively, the pipette can be a standard commercially available machine-operated robotic pipette. Robotic pipettes generally include a pressurised system for drawing in samples, and dispensing them, instead of a plunger, e.g., an electrical air pump connected to a plurality of pneumatic lines. Example commercially available robotic systems include: the “Biomek FX”, from Beckman Coulter, Inc.; the “Microlab STAR” Liquid Handling Workstation, from Hamilton Robotics; and the Precision Microplate Pipetting System from BioTek Instruments, Inc.

The instrumented pipette 100 allows for reactions and measurements to be performed within a single instrumented apparatus. This can allow for analytical procedures and protocols to be simplified, and reduce the influence of operator error by removing one or more dispensing steps. The instrumentation in the instrumented pipette 100 may obviate auxiliary detection units, e.g., potentiometers, chromatographs, spectrofluorometers and mass spectrometers. The costs of executing analytical protocols may be reduced, making them more readily available to small laboratories and medical clinics.

The instrumented pipette 100 may allow the sample size required to perform certain analyses to be significantly reduced compared to lab-scale experimental equipment. The volume of sample required may be in the nanolitres: this is a comparable volume to the amount of residual sample that is typically left in standard pipette tips after pipetting. The instrumented pipette 100 can provide more functionality than a standard lab pipette without greatly changing or disrupting operator workflow for certain procedures. The instrumented pipette 100 retains the familiarity of a standard pipette and may require only insignificant modification of analytical procedures. Use of the instrumented pipette 100 may be appealing to users who are familiar with standard pipette use.

An operator may use the volume setting on the instrumented pipette 100, in conjunction with a disposable tip 104 of a corresponding volume, to approximately define a sample volume, e.g., for determining aliquots, whereas the exact sample size for the experimental procedure is defined by one or more volumes in the experiment region 401 of the experimental component 106. For example the fluid sample size (volume) in an experiment performed by the instrumented pipette 100 can be precisely defined by a fluid chamber 412 in the experimental component 106, as shown in FIG. 4.

The instrumented pipette 100 includes an internal plunger mechanism 308 (for drawing in and ejecting the fluid sample), as shown in FIG. 3, for providing the partial vacuum that draws the fluid sample through the disposable tip 104 into the experimental component 106 of the instrumented pipette 100. The plunger mechanism 308 also provides pressure to dispense or eject the received fluid sample.

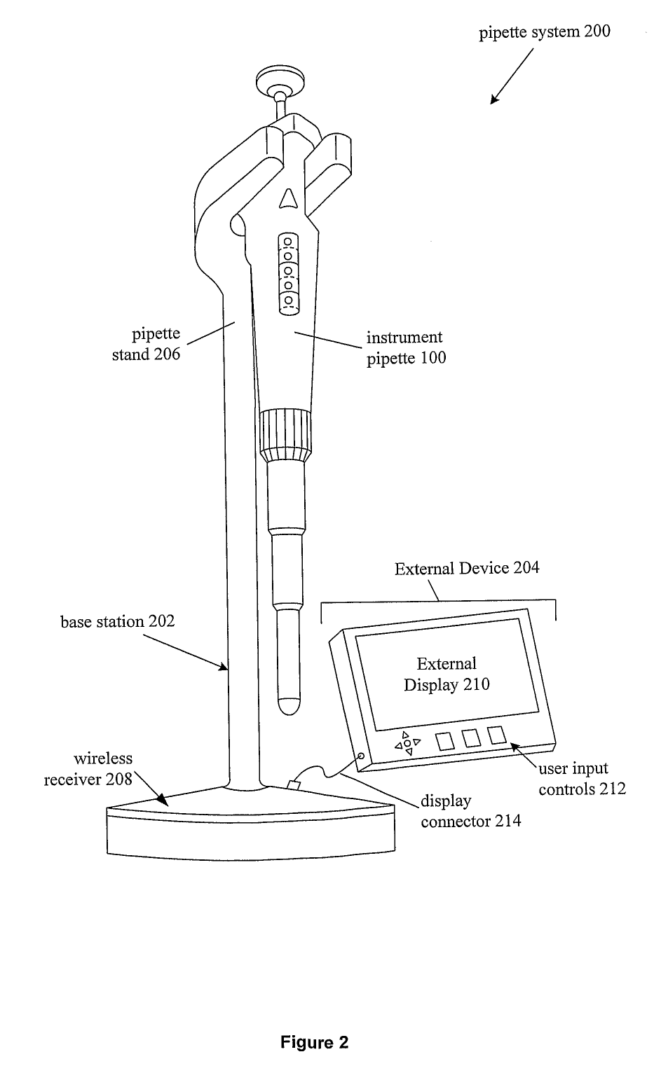

In some embodiments, the instrumented pipette 100 operates in a pipette system 200, as shown in FIG. 2, which includes a base station 202 configured to communicate electronically with the instrumented pipette 100, and an external device 204 configured to communicate with the base station 202.

Information from the experimental component 106 relating to the fluid sample is communicated from the experimental component 106 either directly to the base station 202 or via the integrated electronics of the instrumented pipette 100 to the base station 202. The experimental component 106 transmits information about the fluid sample related to the particular experiment, or measurement, for which the experimental component 106 is configured, as described hereinafter with reference to FIGS. 4 and 5.

In some embodiments, the base station 202 includes a pipette stand 206 for holding and supporting the instrumented pipette 100 while not in use (e.g., while in storage), and a wireless receiver 208 for communicating with the integrated electronics of the instrumented pipette 100. In these embodiments, information about the fluid sample is transmitted from the integrated electronics of the instrumented pipette 100 to the base station 202 using the wireless receiver 208 and a wireless protocol such as: Bluetooth, WiFi, ZigBee, etc. In other embodiments, the base station 202 includes a wired connection to the instrumented pipette 100, e.g., using contact electrodes in the pipette stand 206 that electrically engage with corresponding electrodes on the instrumented pipette 100, to receive information from the instrumented pipette 100 via the wired connection. The wired connection may also be used to power the instrumented pipette 100, e.g., by charging a battery in the instrumented pipette 100.

The external device 204 includes an external display 210 for displaying information based on the measurement signals received from the instrumented pipette 100. The external device 204 includes user input controls 212, such as a keyboard and mouse, for selecting the information to be displayed on the external display 210. The external device 204 is connected to the base station 202 with a display connector 214. In some embodiments, the display connector is a wired connection. In other embodiments, the display connector 214 is a wireless connection, using one of the wireless protocols.

The integrated electronics of the instrumented pipette 100 are housed inside the pipette body 102 and include integrated electronic units 300, as shown in FIG. 3, for transmitting information between the experimental component 106 and the base station 202, and/or the pipette display 116. The integrated electronic units 300 include the wireless transceiver unit 302 for communicating wirelessly with the wireless receiver 208 in the base station 202, a electrode interface unit 304 for receiving information in the form of electronic or optical (electromagnetic) signals from the experimental component 106, and signal conductors 306 for electronically or optically transceiving (sending/receiving) signals between the electrode interface unit 304 and the experimental component 106. In some embodiments, the wireless transceiver unit 302 communicates with a wireless transceiver in the experimental component 106. The electrode interface unit 304 can include an electrical controller for electrically actuating the fluid sample (e.g., for electrolysis etc.), and/or an electrical detector for receiving signals from the fluid sample.

The measurement signals generated by the experimental component 106 represent information about the fluid sample drawn up by the instrumented pipette 100. These signals are detected in the electrode interface unit 304 and transmitted by the wireless transceiver unit 302 to the base station 202 for analysis and/or subsequent storage as data.

The experimental component 106 includes a pipette interface portion 402 for mechanically interfacing with the pipette body 102, and a chip portion 404 in which the experimental procedures with the fluid sample take place, as shown in FIG. 4. The interface portion 402 includes an upper channel 406 in fluid communication with the vacuum chamber of the pipette body 102 and configured to receive the fluid sample when drawn into the instrumented pipette 100. The chip portion 404 includes a fluid chamber 412 for holding the fluid sample (or at least a portion thereof). The fluid chamber 412 is in fluid communication with a micro channel 414 into which the fluid sample is drawn, after it travels through the disposable tip 104, when the plunger 110 is used to draw the fluid into the instrumented pipette 100.

At least a part of the fluid sample can be drawn into or to the fluid chamber 412, or any other part of the experiment region 401, either: (i) by a vacuum pressure exerted by the pump of the pipette body 102; or (ii) by a capillary or wicking effect of a micro-channel or member that draws or wicks liquid from the liquid body in the tip 104 into the fluid chamber 412.

The interface portion 402 can include on-chip signal conductors 408 which extend from the interface configured to contact the pipette body 102 through the interface portion 402 to the chip portion 404. The chip portion 404 includes the on-chip signal conductors 408 leading to the experiment region 401 (and at least one fluid reservoir, such as the fluid chamber 412) where at least part of the experimental procedure takes place. The on-chip signal conductors 408 communicate electronic or optical signals between the experiment region 401 and the integrated electronic units 300. In an example, the on-chip signal conductors 408 can be used to determine the conductivity of a portion of the fluid sample in the fluid chamber 412. Experimental data signals, or measurement signals representing results of the experimental procedure, may be transmitted from the experimental component 106 using electrical or optical connections provided by the on-chip signal conductors 408. As mentioned above, the experimental component 106, in some embodiments, transmits the signals to the integrated electronics of the instrumented pipette 100, whereas in other embodiments the signals are transmitted directly to the base station 202.

In some embodiments, the experimental component 106 includes a seal 416, as shown in FIGS. 4 and 5, removably covering the upper opening of the experimental component 106. The seal 416 substantially seal the interior of the experimental component 106 from its environment when in storage. In particular, the seal 416 resists light/air/fluid/etc. penetrating the experimental component 106 when it contains reactants or materials that can degrade by exposure. For example: (i) the on-chip signal conductors 408 may have electrodes exposed to the fluid chamber 412, and thus the upper channel 406, that may corrode if exposed to air; (ii) the experimental component 106 may include light-sensitive or moisture-sensitive substances or materials, such as lyophilised bio-molecular reagents, which are substantially preserved by being sealed in the experimental component 106. The seal 416 is permeable by the pipette body 102 when the experimental component 106 is attached, e.g., during the operator's normal use of the instrumented pipette 100: when the operator manually attaches the experimental component 106 to the pipette body 102, the shaft tip 114 penetrates/pierces the seal 416, allowing the experimental component 106 to engage with the pipette body 102 so the plunger 110 can exert fluid pressure through the experimental component 106 to draw in the fluid sample. The seal 416 can be made of a membrane, such as cellulose or a synthetic rubber, or a packaging material as used in food packaging (e.g., a multilayer sealing film).

The chip portion 404 can include a generally planar (or “flat”) portion, as shown in FIG. 5 in a side view of the experimental component 106. The planar portion can be more convenient to manufacture than a non-planar implementation of the chip portion 404.

The interface portion 402 is generally circularly symmetrical to allow for a generally fluid-sealing interface with the shaft tip 114, and the upper channel 406 has a generally circular interface at the end of the interface portion 402 configured to join the pipette body 102.

The on-chip signal conductors 408 are arranged in a generally planar position on the chip portion 404, and follow the edge of the interface portion 402 to come into electronic communication with the signal conductors 306 which extend to the shaft tip 114 (not shown).

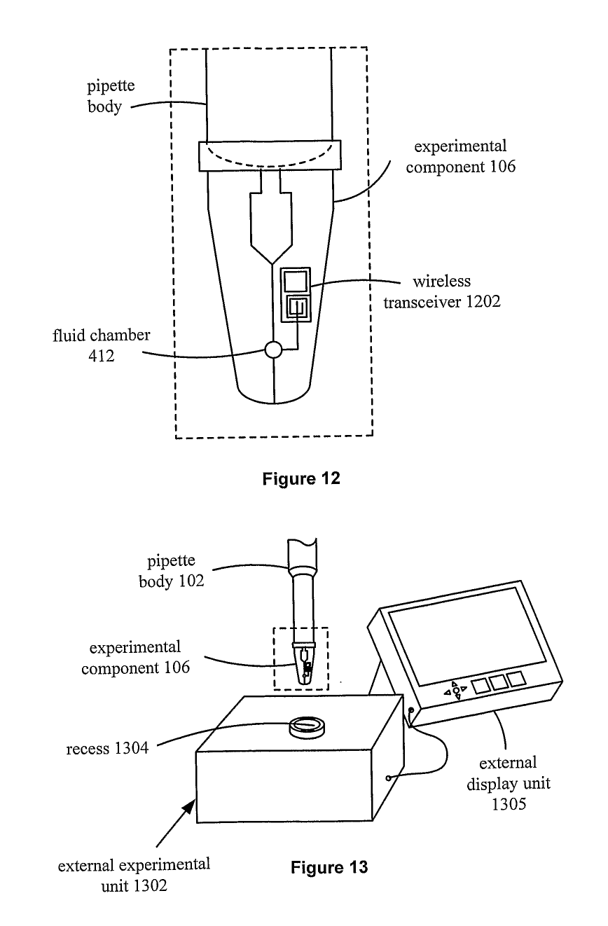

In some embodiments, the experimental component 106 includes a wireless transceiver, described hereinafter with reference to FIG. 12, to pass the measurement signals from the experiment region 401 and/or the on-chip signal conductors 408 directly to the wireless receiver 208 in the base station 202 (rather than via the integrated electronics in the pipette body 102). In these embodiments, the pipette body 102 need not include the integrated electronics, and may be a standard passive commercially available pipette as used in a laboratory.

In some embodiments, the experimental component 106 includes an optical window (not shown) that allows passage of radiation/light into the experimental component 106 to interact with the fluid sample, and/or another part of the experimental component 106. For example: (i) the optical window may be used with a spectroscopic technique to detect/sense the fluid sample, or products of the experimental procedure defined by the experimental component 106; or (ii) the optical window may be used for optical activation/manipulation of the experimental procedure, e.g., for optically activating a bio/chemical reaction in the experimental component 106. The optical window may include optical fibre connectors and components.

In some embodiments, the experimental component 106 includes an array of electrical contacts that are externally accessible. The array of contacts may be separately addressed by electrical signals from an external apparatus to either provide electrical power for the experimental procedure defined by the experimental component 106 (e.g., for electrophoresis), or to sense/detect a property associated with the experimental procedure (e.g., electrical impedance).

The chip portion 404 includes microfluidic and microelectronic structures for performing the experimental procedure on the fluid sample and sending the results of these experiments to the integrated electronics, the base station 202, the pipette display 116 and/or the external display 210.

The use of microfluidic structures on the experimental component 106 can reduce the amount of sample required to perform analysis compared to commercially available lab apparatus, and thus shorten any incubation and overall detection times. By integrating features used in the experimental procedure into the instrumented pipette 100, the workflow and instruments can remain generally familiar to experienced users. By further integrating the electrode interface unit 304 (e.g., a potentiostat) into the instrumented pipette 100, results may obtained and recorded in real time and the need for auxiliary detection units may be reduced.

The chip portion 404 can include one or more sensors for: detecting electrochemical properties of the fluid; making temperature measurements in the experiment region 401; making pH measurements of the fluid in the fluid chamber 412; making complex impedance measurements of fluid in the fluid chamber 412 using the on-chip signal conductors 408; etc. In some embodiments, the chip includes optical sensors, for refractive index, optical absorption, and florescence measurements, linked optically to the pipette body 102: for example, the pipette body 102 can include laser diodes and optical detectors, and the on-chip signal conductors 408 can be in the form of optical fibres for transmitting light to the fluid sample in the fluid chamber 412 and detecting reflected/transmitted/florescent light from the fluid sample. The chip portion 404 can include one or more magnetic coils for detecting magnetic properties of the fluid sample, for example detecting the passage of magnetic beads attached to molecules in, or passing through, the fluid chamber 412. The experiment region 401 can include a piezo-electric device driven by electrical signals of the on-chip signal conductors 408 to detect a viscosity of the fluid in the fluid chamber 412, or a mass of any molecules attached to the piezo-electric transducer, or a surface connected to the piezo-electric transducer. The experiment region 401 can also include one or more nanowires or other nano structures, for increasing the surface area of the sensor. The experiment region 401 can also include surface treatments, to provide hydrophilicity, hydrophobicity, specific binding and non-specific binding between molecules or particles in the sample fluid and the structures of the experimental component 106.

The chip portion 404 can include stored reagents in reagent chambers, connected by fluidic channels to the experiment region 401, including: wet reagents, localised reagents, external reagents and dry reagents. Example stored reagents can include: selected nucleic acids, selected proteins, selected enzymes, etc.

The chip portion 404 can include a capillary channel, and/or a hydrophilic substrate for pumping, channelling and holding of the fluid sample.

The interface portion 402 and the chip portion 404 form a housing for the features used in the experimental procedure, e.g., the on-chip conductors 408, the fluid chamber 412, the micro channel 414, and other experimental structures (e.g., the fluidic/microfluidic structures, electronic/microelectronic structures and optical/photonic structures).

### Experimental Methods

The instrumented pipette 100 is generally used for performing the experimental procedure with a fluid sample. A use, a human operator (or in some embodiments a robotic operator) fits or engages the experimental component 106 to the body 102, then fits or engages the disposable tip 104 (in the form of one of a plurality of possible replaceable tips) to the experimental component 106. At least part of a fluid sample of interest can be drawn into tip 104 by operating the pipette, which then draws fluid into or at least onto the experimental component 106 (as the experimental component 106 extends at least partially into the installed tip 104). At least part of the experimental procedure is performed in the experimental component 106 using the at least part of the fluid sample. The tip 104 can be removed or ejected from the experimental component 106 by pulling the tip 104 from the experimental component 106 (e.g., by hand or using an additional grasping apparatus), or by operating one or more ejectors of the pipette body 102. In a multi-stage experimental procedure, a further replaceable tip 104 can be fitted to the experimental component 106: the further tip can be used to draw in a further fluid sample without contaminating the source of the further fluid sample with any part of the first fluid sample because the further tip is a clean and new replaceable tip. The further fluid sample (which is generally part of some larger body of fluid) is drawn into the pipette component by operating the pipette, and a further part of the experimental procedure is performed using the further fluid sample in the experimental component 106. A plurality of further tips can be fitted, and respective fluids drawn into the experimental region 401, in a multi-stage experimental procedure. The experimental component 106 can be ejected from the pipette body 102 by operating an ejector of the pipette body 102, or by grasping and removing the experimental component 106. The experimental component 106 is generally replaceable, and a separate experimental component 106 can be used for each iteration, or repeat, of an experimental procedure, thus keeping the samples, and the experimental structures on each fresh experimental component, uncontaminated.

Performing at least part of the experimental procedure using the experimental component 106 can include generating one or more measurement signals by measuring a sample property associated with one or more fluids in the experimental component 106, and signals corresponding the measurement signals can be transmitted from the experimental component 106 using an on-chip/built-in transmitter system in the experimental component 106. The transmitter system can communicate with an external receiver system that receives the transmitted signals, as described hereinbefore.

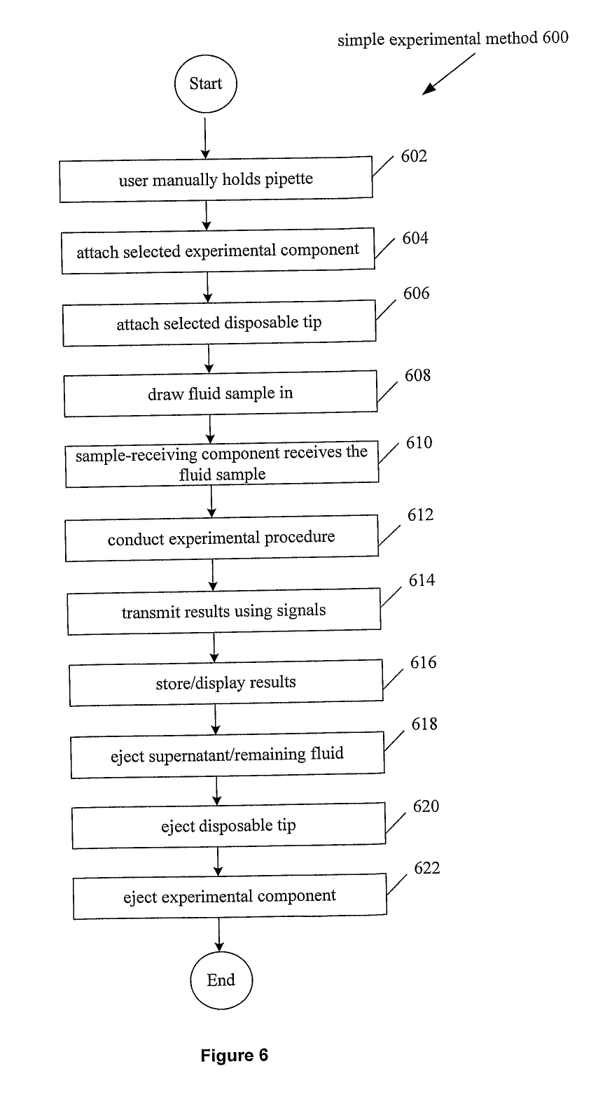

The instrumented pipette 100 may be used in a simple experimental method 600 (i.e., a simple method of use), as shown in FIG. 6, which begins with the user manually holding the instrumented pipette 100 as in a typically pipetting workflow (step 602). The user selects a form or embodiment of the experimental component 106 that defines an experimental procedure that the user wishes to perform, such as a selected immunoassay. The user attaches the selected experimental component 106 to the shaft tip 114 of the pipette 100, thereby piercing/removing the seal 416, and forming a generally fluid-impermeable seal between the pipette body 102 and the experimental component 106 (step 604). The user selects the form of the disposable tip 104 depending on the volume of fluid the user intends to draw into the pipette 100: for example, the selected experiment may define a certain volume, or the user may wish to divide the sample volume into predetermined aliquots, or the user may wish to select a volume for the dispensed liquid in a secondary experiment. The user then attaches the selected disposable tip 104 to the end of the pipette 100, which therefore fits onto or over the experimental component 106 to form a further generally fluid-impermeable seal between the disposable tip 104 and the experimental component 106 (step 606). The user actuates the plunger 110 to generate a vacuum and draw the fluid sample into the pipette 100, and into the experimental component 106 (step 608). The fluid sample is drawn into the fluidic structures on the chip portion 404 which define the experiment: in some embodiments the fluid sample is drawn into the experiment region 401 (step 610). In some embodiments the fluid sample is drawn along the micro channel 414 and into the fluid chamber 412. With the fluid sample in the chip portion 404, the experimental component 106 performs at least part of the experimental procedure as defined by its experimental structure s (step 612). In some embodiments, electrical current is applied to the fluid sample in the fluid chamber 412 using the on-chip signal conductors 408 at a selected electronic frequency. During and/or after the experiment, the sensed results from the experiment are transmitted from the experimental component 106 as measurement signals (step 614). In some embodiments, the results are transmitted using electronic or optical signals following the on-chip signal conductors 408. In other embodiments, the results are transmitted wirelessly from the experimental component 106. The instrumented pipette system 200 stores and/or displays the results from the experiment when they are received by a receiver (step 616). In some embodiments, the receiver is in the electrode interface unit 304 integrated into the instrumented pipette 100. In other embodiments, the receiver is in the base station 202 or the external device 204. The fluid sample remains in the experimental component 106 for a sufficient length of time to complete the experiment (e.g., for an incubation period), after which the user ejects the fluid sample, or the supernatant, using the plunger 110 in the standard workflow of pipette usage (step 618). The fluid sample may be ejected as waste when the experiment is complete, or may be dispensed into a vessel for further experimentation. The user controls the pipette 100 to eject the disposable tip 104 as in the normal workflow usage of the pipette 100 (step 620). For an embodiment of the experimental component 106 configured for single use, the user ejects the experimental component 106 (step 622) in preparation for inserting a new uncontaminated experimental component 106 for the next series of experiments, returning to repeat step 604. For a multi-use experimental component 106 that is configured to be used multiple times, the user may retain the multi-use experimental component 106 instead of ejecting it in step 622, and may simply re-use the multi-use experimental component 106 with a new uncontaminated disposable tip 104 in further iterations of the experiment, returning to repeat step 606.

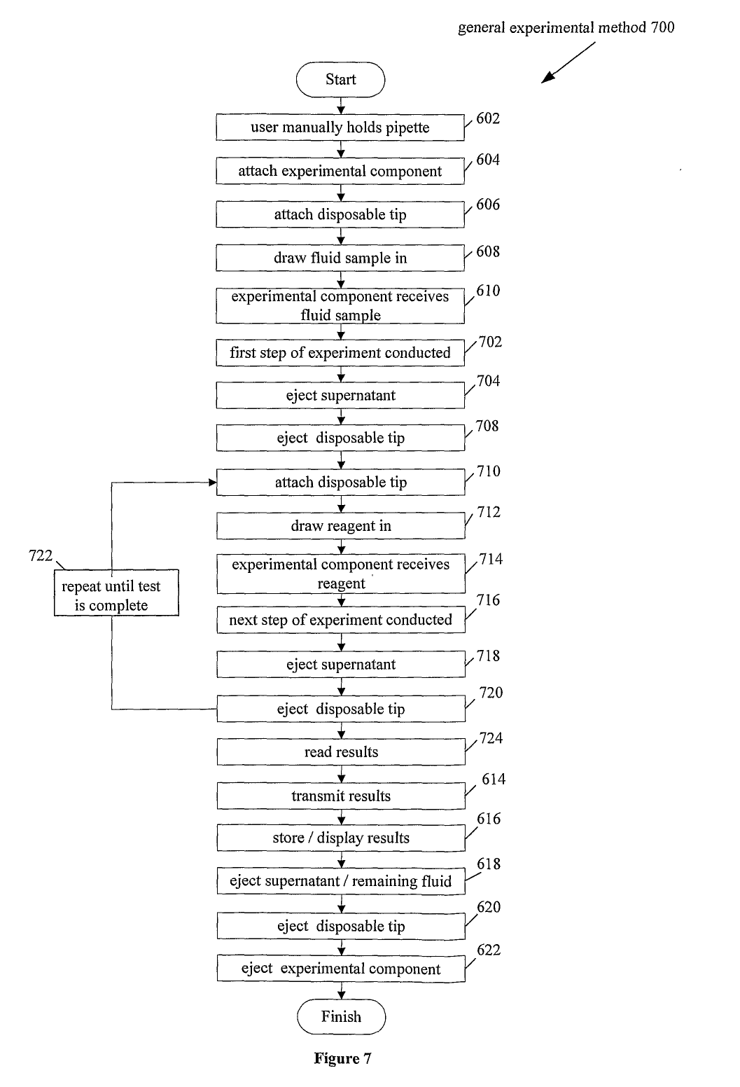

The instrumented pipette 100 may also be used in a general experimental method 700 (i.e., a general method of use), as shown in FIG. 7, which begins with the same steps (i.e. steps 602, 604, 606, 608 and 610) and ends with the same steps (i.e., steps 614, 616, 618, 620 and 622) as the simple experimental method 600. In the general experimental method 700, however, the experimental procedure step 612 of the simple experimental method is replaced with a plurality of steps, which allows for the drawing up (or loading) of one or more additional reagents, e.g., in a sequence forming the experimental procedure. As the disposable tip 104 can be changed between drawing up the reagents, they can be drawn into the experimental component 106 without contaminating each reagent reservoir. In the general experimental method 700, as shown in FIG. 7, a first experimental step is conducted on the fluid sample (step 702), and then a first supernatant (e.g., the remaining fluid, or the volume of the fluid sample not bound or captured in the experimental component 106) is ejected from the instrumented pipette 100 (step 704). A first disposable tip 104 is ejected, or disposed of, from the instrumented pipette 100 (step 708). A clean new second disposable tip 104 is attached to the instrumented pipette 100 by the operator (step 710), and a different second fluid (e.g., a reagent) is drawn into the experimental component 106 (step 712), where it is received (step 714), for conducting the next experimental step in the experimental procedure (step 716). Once the second fluid/reagent has reacted etc., a resulting second supernatant is dispensed from the instrumented pipette 100 (step 718) and the second disposable tip 104 is ejected (step 720). In some embodiments, having a plurality of reagents and/or reactants, the steps of attaching a fresh disposable tip 104 and drawing in a further reagent/reactant (i.e., steps 710, 712, 714, 716, 718 and 720) are repeated (step 722) at least once. Following completion of the experimental steps, the results of the experiment(s) are read (step 724), and then transmitted etc. following the steps at the end of the simple experimental method 600 (i.e., steps 614, 616, 618, 620 and 622).

### Ejectors

The instrumented pipette 100 includes ejectors for ejecting the replaceable or disposable tip 104 and/or the experimental component 106 without the operator having to touch the disposable tip 104 or the experimental component 106.

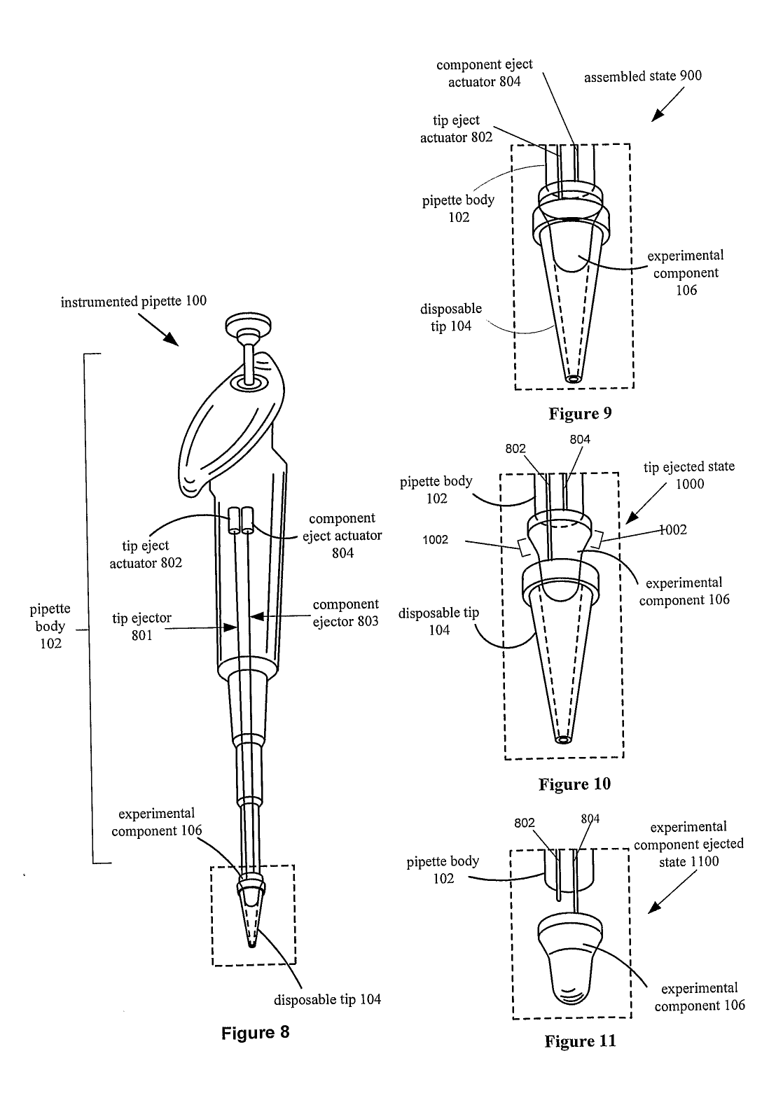

In some embodiments, as shown in FIG. 8, the instrumented pipette 100 includes a plurality of ejectors, including a tip ejector 801, with a tip eject actuator 802, for ejecting the disposable tip 104, and a separately operable component ejector 803, with a component eject actuator 804, for ejecting the experimental component 106. The separate operation of the two ejectors 801, 803 is described above in the general experimental method 700.

In an assembled state 900, as shown in FIG. 9, the experimental component 106 is sealingly engaged with the pipette body 102, in the typical experimental condition of use, and the component ejector 803 is generally proximate the experimental component 106 while not exerting substantial force on it. The disposable tip 104 is sealingly engaged with the experimental component 106 (and thus the pipette body 102) in the experimental condition of use, and the tip ejector 801 is generally proximate the disposable tip 104 while not exerting substantial force on it.

The disposable tip 104 can be ejected by the operator activating the tip eject actuator 802, which applies an ejecting force to the disposable tip 104 (e.g., by using a member, or mechanical pin, or a sheath pushing along the pipette shaft 112) to push the disposable tip 104 from the shaft tip 114. The ejecting pin of the tip ejector 801 can be projected by force beyond the interface of the experimental component 106 and the pipette shaft 112, as shown in FIG. 10, thus forcing the disposable tip 104 from the pipette body 102, to achieve a tip ejected state 1000. The experimental component 106 can have a channel or groove in its housing to allow the tip ejector 801 to slide relative to the experimental component 106 to eject the disposable tip 104 without moving/dislodging the experimental component 106. An example tip interface 1002, onto which the disposable tip 104 engages, is on an outer part of the housing of the experimental component 106, as shown in FIG. 10.

The operator can operate the component ejector 803 to eject the experimental component 106 from the pipette body 102 separately from the ejection of the disposable tip 104. An ejecting pin of the component ejector 803, as shown in FIG. 11, can exert an ejecting force on the experimental component 106 by applying an ejecting force to a bearing surface on an upper part of the experimental component 106, and by projecting beyond the shaft tip 114. With the experimental component 106 ejected from the pipette body 102 by the component ejector 803, the instrumented pipette 100 achieves an experimental component ejected state 1100.

In some embodiments, the tip ejector 801 and the component ejector 803 may be operated manually using only mechanically sliding pins on the pipette body 102. In other embodiments, the ejectors 801, 803 are operated using electronic switches/buttons which activate the tip eject actuator 802 and the component eject actuator 804.

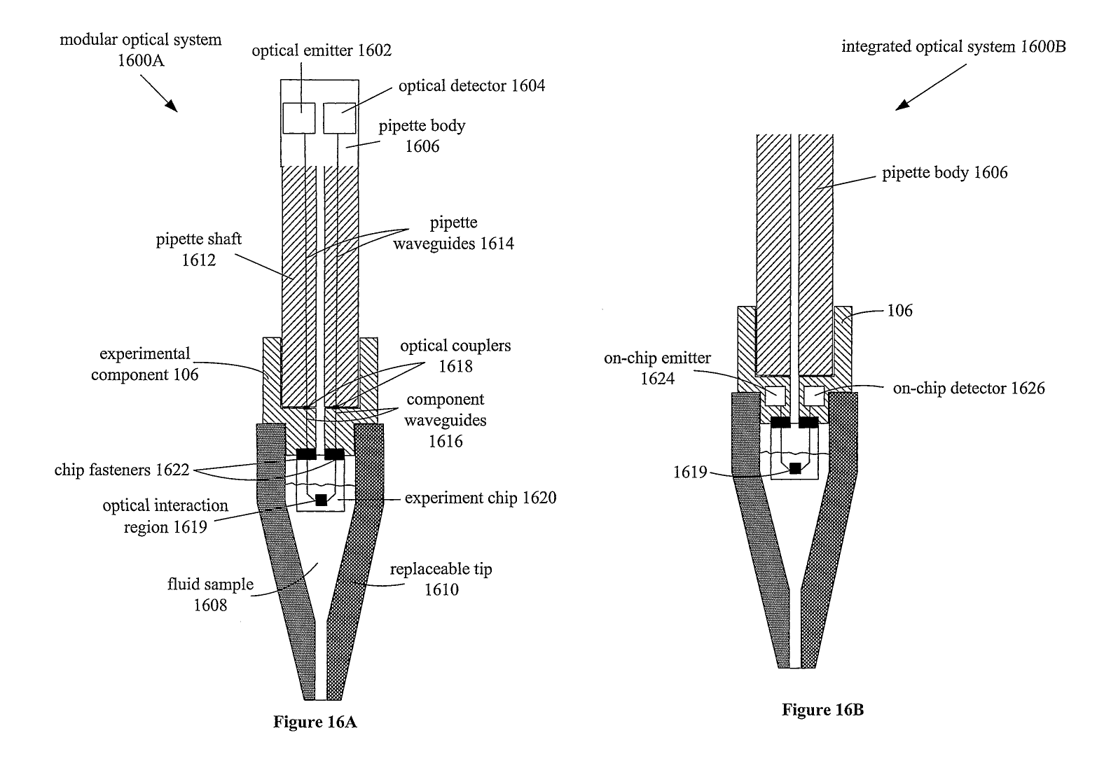

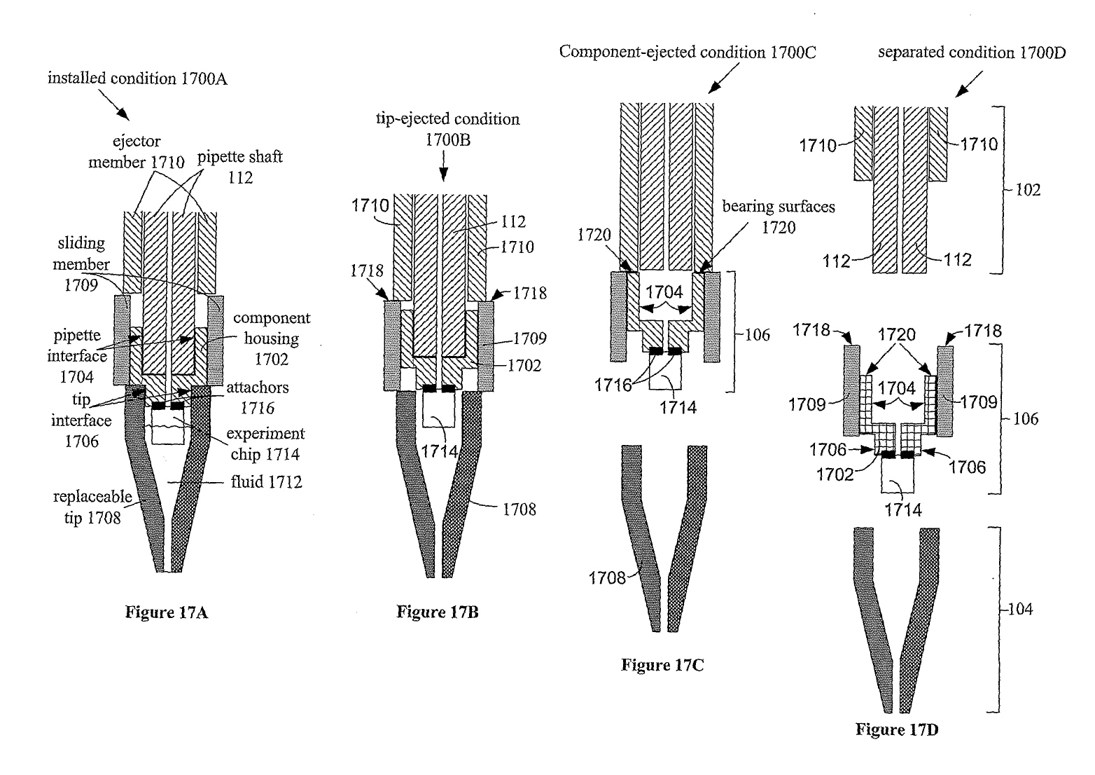

In some embodiments, the experimental component 106 includes an externally sliding sleeve or member for transferring the tip ejecting force for the disposable tip 104 past the housing of the experimental component 106, as described hereinafter with reference to FIGS. 17A-17D.

### Wireless Transceiver

In some embodiments, as shown in FIG. 12, the experimental component 106 includes a wireless transceiver 1202, e.g., integrated in the chip portion 404. The wireless transceiver 1202 is used for transmitting the measurement signals from the experimental component 106 to external systems (such as the external device 204) for recording and analysis of results of the experimental procedure performed using the experimental component 106. The wireless transceiver 1202 is in communication with the experiment region 401 using electrical conductors. The wireless transceiver 1202 typically detects electrical signals from the experiment region 401, conditions these signals for transmission (e.g., by amplification, de-noising, translation to a communications protocol, etc.) and transmits them from the experimental component 106 using an antenna, such as used in radio frequency identification (RFID) tags or wireless chips (e.g., WiFi, Bluetooth, ZigBee, etc.). The wireless transceiver 1202 may also act as a recipient of wireless energy, e.g., for powering electronic components of the experiment region 401. For example, the wireless transceiver 1202 may include a passive RFID chip, in communication with the experiment region 401, which is probed using externally generated pulses of radio frequency (RF) energy. The wireless transceiver 1202 may include an induction loop to receive electrical power from an external generator. The wireless transceiver 1202 can transmit wireless signals to the external receiving station and the wireless receiver 208 in the form of an external experimental unit 1302, as shown in FIG. 13.

In some embodiments, the wireless transceiver 1202 can be part of a near-field wireless system, based on RFID technology, as described hereinafter. In other related embodiments, the transceiver 1202 can be a simple analogue passive device, e.g., an antenna connected to a circuit that has electrical properties (such as a resonance frequency) that change based on physical changes around the circuit. For example, the simple antenna could be connected to a capacitor into which a part of the fluid sample could be drawn, thus affecting the capacitance of the capacitor, and thus the electrical properties of the antenna circuit. This can be referred to as using a radio-frequency (RF) backscatter technique to monitor the “passive” sensors (i.e., having zero power supplied to them apart from that received from the simple antenna itself). In use, a probing platform sends an RF signal to probe the passive sensor. The passive sensor contains a transducer that acts like an impedance to RF signals, and therefore produces a quantifiable backscatter depending on the value of that impedance. This RF impedance reflects the physical parameter under observation. The heterodyned signal from the incident and backscattered RF signals, as in a frequency modulated continuous wave (FMCW) radar, is a low frequency signal containing information on the impedance that can be extracted by digital signal processing (DSP). There are a number of example transducers, especially ones that are based on micro-electro-mechanical (MEMS) chips, which can thus be characterized at RF, and the physical parameter information thus extracted.

The external experimental unit 1302 includes a recess 1304 for accepting the experimental component 106, and one or more external wireless transceivers for receiving signals from the wireless transceiver 1202 (and in some embodiments generating power to transmit to the wireless transceiver 1202). The external experimental unit 1302 receives signals from the wireless transceiver 1202 representing results of the experimental(s) performed using the experimental component 106, and sends signals or data, based on the received signals, to an external display unit 1305, which may be an external computing device for viewing and storing the data/signals. The external experimental unit 1302 can include at least one of: an inductive loop for transmitting power to the experimental component 106; a receiver for receiving measurement signals from the experimental component 106 (via wired electronic connectors, or a wireless antenna); and a photodetector for detecting optical signals from the experimental component 106.

The experimental component 106 can be inserted into the recess 1304 to provide a low-interference wireless path between the wireless transceiver 1202 and the one or more transceivers of the external experimental unit 1302. The experimental component 106 may be inserted into the external experimental unit 1302 while attached to the pipette body 102. Alternatively, the experimental component 106 may be ejected from the pipette body 102 into the recess 1304, where information and signals from the experimental component 106 are received by the external experimental unit 1302.

### APPLICATION EXAMPLES

The experimental procedure performed using the experimental component 106 can include one or more of the following functions, defined by microfluidic components: filtering (e.g., blood filtering), fluidic mixing, adding reagents (e.g., lyophilised stored substances), affinity matrix filtering (e.g., capturing desired target molecules, or capturing undesirable contaminant molecules), and valving (e.g., such as check valving, and valving into waste fluid reservoirs).

The experimental component 106 can be configured to define at least parts of alternative immunoassays, sensing experiments and test protocols (e.g., simple physical sensing processes, preparation of samples for spectrometric analysis, molecular diagnostics, etc.) that are known in the art. Various antigens known to those skilled in the art can be detected using embodiments of the experimental component 106. For performing immunoassays, and other selective experimentation, the experiment region 401 includes surface treatments, such as of specific antigens or antibodies, for detecting selected molecules. The surface treatments of one or more portions of the chip portion 404 may also include coatings of hydrophilic substances, hydrophobic substances, selected nucleotide sequences etc. The chip portion 404 may include reservoirs of stored activating components in the experiment, such as catalysts, reagents, and reactants used in the experimental procedure.

The experimental component 106 can include a microfluidic waste collection area to which the fluid sample is directed once the necessary incubation period in the experiment region 401 has expired.

The information display of the pipette display 116 or the external display 210 can display analytical results, signature data from the experiment, environmental conditions, and/or an operator error alert when a wanted parameter (such as pH) is unexpectedly different in one of a series of experiments. The instrumented pipette 100 may be single tipped, or multi-tipped for drawing in multiple fluid samples to the same experimental component 106 simultaneously. The instrumented pipette 100 may include a location sensor, defined by microelectronics in the chip portion 404 (such as a wireless location-sensitive chip), for tracking the location of the instrumented pipette 100, which is then displayed on the external display 210 and used to monitor any errors in the user's workflow, such as the instrumented pipette 100 being removed from a pre-selected area for the experiments.

### Application Example

### Temperature Sensor

In some embodiments, the experimental component 106 includes a temperature sensor for sensing the temperature of the fluid sample, or at least the temperature in the experiment region 401. The temperature sensor generates a temperature signal which may be used to detect any unexpected changes in temperature, for example an unwanted temperature change of the experiment region 401 due to the pipette 100 heating. The pipette 100 may change temperature due to heat from the user's hand in periods of prolonged use. The temperature of the fluid sample in the experimental component 106 may change in temperature if the room temperature differs from the fluid's initial temperature (e.g., if the fluid had been stored in a cold or hot environment, such as a refrigerator or an incubator). If the detected temperature reaches a predefined threshold, the system 200 can generate an alert to notify the user of the unwanted temperature.

### Application Example

### Immunoassay

In some embodiments, the experimental component 106 is used to perform an immunoassay experiment in which the chip portion 404 includes an electro-chemical sensor that detects/measures the presence/concentration of a target, e.g., a protein, in the fluid sample. The immunoassay component 106 is used in four steps with four fluid samples: a reagent solution, a wash solution, a sample solution and an indicator solution. As each solution comes into contact with the sensor in the experiment region 401, the on-chip signal conductors 408 generate a reading of the electrical potential, or voltage, across the fluid sample in the defined volume of the fluid chamber 412 using a potentiostat in the electrode interface unit 304. The instrumented pipette system 200 records and displays the potential readings of the four solutions, and determines from these readings the concentration of the target species in the sample solution.

### Application Example

### Competitive Enzyme-Linked Immunosorbent Assay (c-ELISA) for Toxin Detection

In some embodiments, the experimental component 106 is configured to detect a metabolised toxin, such as Aflatoxin M1 (which may be in agricultural products such as milk and milk products), using a competitive Enzyme-Linked Immune-Sorbent Assay (c-ELISA) protocol.

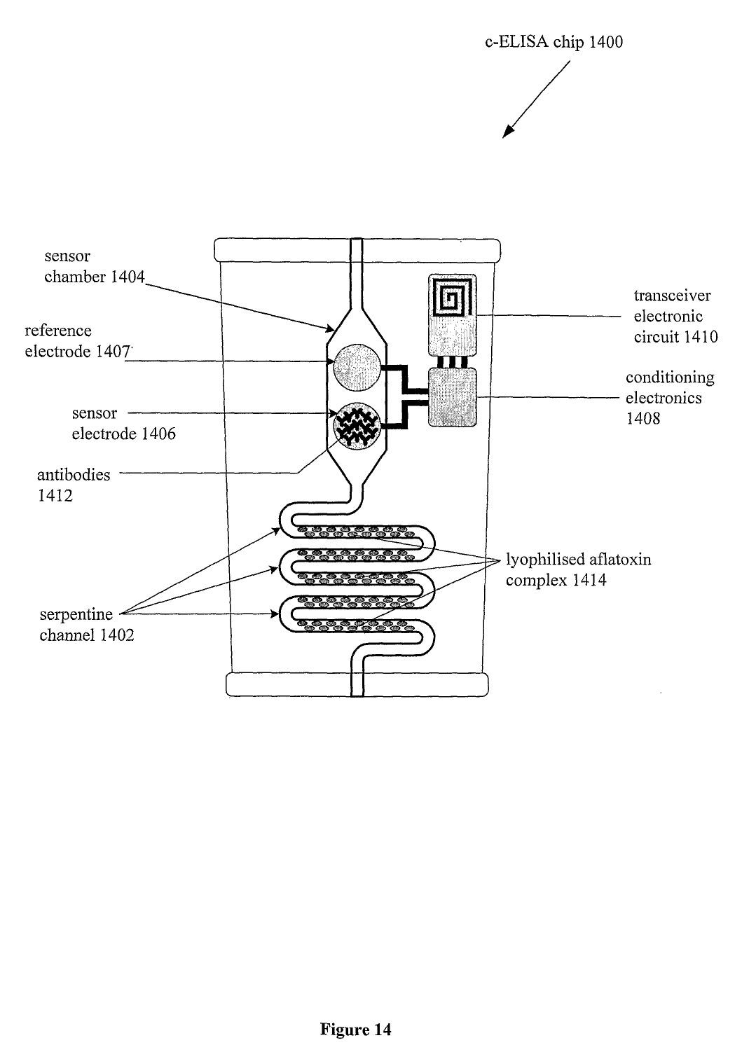

As shown in FIG. 14, a c-ELISA chip 1400 of the experimental component 106 contains a serpentine mixing channel 1402, a sensor chamber 1404, an electrochemical sensor (which includes a sensor electrode 1406 and a reference electrode 1407) in the sensor chamber 1404, conditioning electronics 1408 for signal conditioning, and a transceiver electronic circuit 1410 (including an in-built antenna) for wireless energy and signal transmission. The sensor electrode 1406 includes one or more monoclonal Aflatoxin M1 capture antibodies 1412 substantially immobilised onto a sensing surface of the sensor electrode 1406 using immobilizing bonds. The immobilizing bonds may be based on different immobilization techniques, for example: (i) a covalent interaction between an atomic structure on the sensing surface (e.g., a functionalised surface layer formed on the sensing surface by modifying the chemistry of the sensing surface); or (ii) an interaction between one or more molecules bound to the sensing surface and the capture antibodies 1412 (e.g., where the bound molecules include Avidin or Streptavidin, and the interaction is the biotin-streptavidin interaction).

A stored substance in the form of a lyophilised enzyme-labelled Aflatoxin complex 1414 (such as Horseradish Peroxidase (HRP)-labelled Aflatoxin M1) is stored in the serpentine channel 1402. The serpentine channel 1402 is shaped to encourage/cause substantial mixing between the lyophilised complex 1414 and the fluid sample, and thus provide for rehydration and mixing of a substantial fraction—if not substantially all—of the lyophilised complex 1414. The lyophilised complex 1414 can be added to the serpentine channel 1402 during assembly of the experimental component 106. Alternatively, the lyophilised complex 1414 can be added by first adding a solution, then removing the solvent using a lyophilisation process.

In use of the c-ELISA chip 1400, the operator attaches the experimental component 106 to the pipette shaft 112, and then attaches a disposable tip 104 to the experimental component 106. The operator introduces the instrumented pipette 100 into a vial containing the fluid sample to be tested. By pushing and releasing the plunger 110, the operator loads a predefined volume of the fluid into the experimental component 106. Under the applied suction (negative pressure) applied by the plunger mechanism 308, the fluid sample is forced into and through the serpentine channel 1402, where the fluid sample rehydrates the lyophilised Aflatoxin complex 1414. The re-hydrated enzyme-labelled complex 1414 mixes with the fluid sample to form a mixture of fluid sample and the enzyme-labelled complex 1414. Under the applied suction (and/or capillary pressure), the mixture flows from the serpentine channel 1402 into the sensor chamber 1404, where it interacts with the capture antibodies 1412. Both the unlabeled Alfatoxin M1 antigen in the fluid sample and the enzyme-labelled Aflatoxin complex 1414 (HRP-labelled Aflatoxin M1 reconstituted from the serpentine channel) can bind to the capture antibodies 1412, thus providing a competitive binding process: the un-labelled Aflatoxin M1 in the sample competes with the enzyme-labelled Aflatoxin complex 1414 (HRP-labelled Aflatoxin M1 antigens) already in the experimental component 106 for a finite number of immobilized Aflatoxin M1 antibody binding sites of the capture antibodies 1412.

The operator ejects the supernatant (including any of the fluid sample and the enzyme-labelled Aflatoxin complex 1414 not bound to the capture antibodies 1412) from the c-ELISA chip 1400 into waste (e.g., an external vial for waste) by pushing the plunger 110. The operator ejects the disposable tip 104 from the experimental component 106, and attaches a new clean disposable tip 104. The operator then introduces the instrumented pipette 100 into a vial containing a wash buffer. By pushing and releasing the plunger 110, the operator loads a predefined volume of wash buffer into the c-ELISA chip 1400, where the wash buffer substantially removes any unbound species from the sensing surface and the sensor chamber 1404. The operator ejects the used wash buffer from the c-ELISA chip 1400 into waste by pushing the plunger 110. The operator ejects the disposable tip 104 from the experimental component 106, and attaches a further new clean disposable tip 104. The operator introduces the instrumented pipette 100 into a vial containing an enzyme substrate, e.g., a peroxidase substrate such as o-phenylenediamine dihydrochloride (OPD). By pushing and releasing the plunger 110, the operator loads a predefined volume of the enzyme substrate into the sensor chamber 1404. The enzyme substrate causes the enzyme conjugate to become electrochemically active during substrate turnover. A change in potential on the surface of the sensor/electrode 1406 is measured with reference to the reference electrode 1407 by the conditioning electronics 1408. As the un-labelled Aflatoxin M1 in the fluid sample and the enzyme-labelled Aflatoxin complex 1414 in the c-ELISA chip 1400 competed for the finite number of immobilized Aflatoxin M1 antibody binding sites in the sensor electrode 1406, a decrease in the electrical signal detected by the conditioning electronics 1408, which is due to binding of the enzyme-labelled Aflatoxin complex 1414 to the capture antibodies 1412, indicates the presence of the Aflatoxin M1 (and hence the presence of Aflatoxin) in the examined sample when compared to samples with HRP-labelled Aflatoxin M1 alone. The conditioned sensor signal is transmitted, using the in-built antenna of the transceiver electronic circuit 1410, to the wireless receiver 208 and the external device 204.

### Application Example

### Sandwich Enzyme-Linked Immunosorbent Assay (s-ELISA) for Cancer Marker Detection

In some embodiments, the experimental component 106 may be configured for detecting a panel of cancer markers such as Prostate Specific Antigen (PSA)—in its free and complex forms—and thus detecting prostate cancer at an early stage using a sandwich enzyme-linked immune-sorbent assay (s-ELISA) protocol.

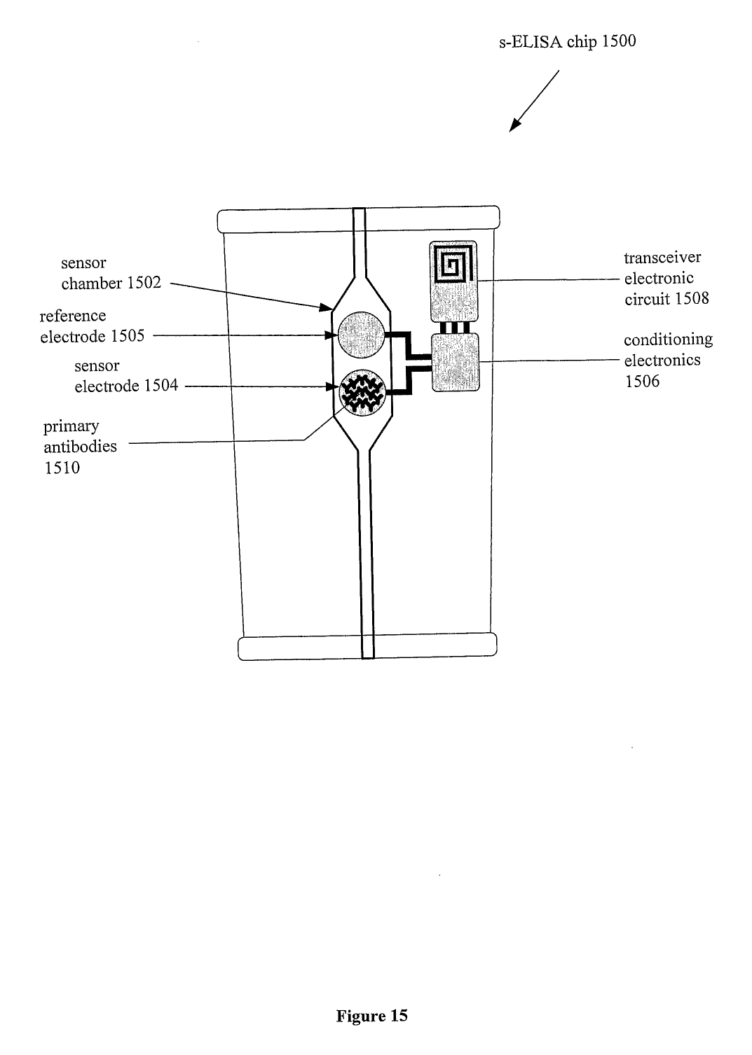

As shown in FIG. 15, an s-ELISA chip 1500 of the experimental component 106 contains a sensor chamber 1502, an electrochemical sensor (including a sensor electrode 1504 and a reference electrode 1505) in the sensor chamber 1502, a conditioning electronics 1506 for signal conditioning and a transceiver electronic circuit 1508 for wireless energy and signal transmission. Primary PSA antibodies 1510 (e.g., first monoclonal mouse antibodies) against at least one selected first epitope on the PSA antigen are immobilised onto a sensing surface of the sensor electrode 1504 using covalent bonds as described above with reference to the c-ELISA chip 1400.

In using the s-ELISA chip 1500, the operator attaches the experimental component 106 to the pipette shaft 112, and then attaches a disposable tip 104 to the experimental component 106. The operator introduces the instrumented pipette 100 into a vial containing the fluid sample to be tested. By pushing and releasing the plunger 110, the operator loads a predefined volume of the fluid sample into the experimental component 106. The fluid sample is forced into the sensor chamber 1502, where it interacts with the primary PSA antibodies 1510. If PSA antigens are present in the fluid sample, they will bind to the primary PSA antibodies 1510. The operator ejects the supernatant from the experimental component 106 into waste by pushing the plunger 110. The operator ejects the used disposable tip 104 and attaches a new clean disposable tip 104. The operator introduces the instrumented pipette 100 into a vial containing a wash buffer. By pushing and releasing the plunger 110, the operator loads a predefined volume of wash buffer into the s-EILSA chip 1500, where it substantially removes any unbound species from the sensor surface of the sensor electrode 1504 and from the sensor chamber 1404. The operator ejects the used wash buffer from the experimental component 106 into waste by pushing the plunger 110. The operator ejects the disposable tip 104 from the experimental component 106, and attaches a clean disposable tip 104.

The operator introduces the instrumented pipette 100 into a vial containing a fluid with secondary PSA antibodies (e.g., second monoclonal mouse antibodies that differ from the first monoclonal mouse antibodies) against a selected second and different epitope on the PSA antigen, conjugated with an enzyme such as HRP. The operator loads a predefined volume of the fluid with the secondary PSA antibodies into the s-ELISA chip 1500. If PSA antigens are present in the fluid sample, the secondary PSA antibodies bind to the captured PSA antigens on the primary PSA antibodies 1510. The operator ejects the supernatant from the experimental component 106 into waste by pushing the plunger 110. The operator then ejects the disposable tip 104 from the experimental component 106, and attaches a clean disposable tip 104. The operator then introduces the instrumental pipette 100 into a vial containing a wash buffer. The operator loads a predefined volume of the wash buffer into the experimental component 106, where it removes any unbound species from the electrochemical sensor and the sensor chamber 1502. The operator then ejects the used wash buffer from the c-ELISA chip 1400 into waste by pushing the plunger 110. The operator ejects the disposable tip 104 from the experimental component 106, and attaches a clean disposable tip 104.

The operator introduces the instrumental pipette 100 into a vial containing an enzyme substrate, such as o-phenylenediamine dihydrochloride (OPD) or peroxidase. By pushing and releasing the plunger 110, the operator loads a predefined volume of the enzyme substrate into the sensor chamber 1502. The enzyme substance causes the enzyme conjugate to become electrochemically active during substrate turnover. A change in potential on the sensor surface is measured between the reference electrode 1505 and the sensor electrode 1504 by the conditioning electronics 1506. The conditioned sensor signal is transmitted via the transceiver electronic circuit 1508, including an in-built antenna, to the wireless receiver 208 and the external device 204. The detected concentration levels of the target PSA antigen in the fluid sample are indicative of the state of prostate cancer in a patient.

### Materials and Manufacturing Techniques

The experimental component 106 may be manufactured as a single part or may be assembled from several parts which are manufactured independently and are joined to form the experimental component 106. The parts of the experimental component 106 include at least the one or more fluidic/microfluidic structures, the one or more electronic/microelectronic structures, the one or more optical/photonic structures, the component housing, the seal 416, the interface portion 402, and the chip portion 404.

In some embodiments, the experimental component 106 or its parts are manufactured using one or more materials selected from the group including: cyclic olefin copolymer (COC), polycarbonate (PC), polystyrene (PS), polymethyl-methacrylate (PMMA), polyethyl-eneterephthalate (PET), polyimide (PI), polyetherimide (PEI), polydimethylsiloxane (PDMS), acrylonitrile butadiene styrene (ABS), cellulose acetate (CA), cellulose acetate butyrate (CAB), high density polyethylene (HDPE), low density polyethylene (LDPE), polyamide (PA), polybutylene terephtalate (PBT), polyether block amide (PEBA), polyether ether ketone (PEEK), polyethylene terephtalate glycol (PETG), polymethyl-pentene (PMP), polyoxide methylene (POM), polypropylene (PP), polysulfone (PSU), polytetrafluoroethylene (PTFE), polyvinylchloride (PVC), polyvinylidene chloride (PVDC) or polyvinylidene fluoride (PVDF) or combinations thereof. Preferably the material selected has high strength and high dimensional stability coupled with a high coefficient of elasticity. Preferably the material selected has low water vapour permeability and low water absorption. The optical transparency, oxygen permeability and carbon dioxide permeability of the material for each embodiment of the experimental component 106 are selected based on requirements of the corresponding experimental procedure.

The experimental component 106 or its parts may be manufactured using microfabrication techniques known to those of skill in the art, including replication techniques such as hot embossing, stamping, die-cutting, thermo-forming and injection moulding, and subtractive microstructuring techniques such as laser cutting, micromilling or similar mechanical microfabrication techniques.

In some embodiments, the experimental component 106 is assembled from two or more parts, and internal sealing gaskets are be used to seal parts of the assembled components. These internal sealing gaskets may be manufactured using microfabrication techniques, including replication techniques such as cast moulding, compression moulding, injection moulding, reactive injection moulding, die cutting, or polymerising the precursor polymers within the mould. The assembly and bonding of the two or more parts may use lamination, adhesive bonding, adhesive tape bonding, solvent bonding, thermal diffusion bonding, UV-assisted thermal diffusion bonding, plasma-assisted thermal diffusion bonding, chemical etching assisted diffusion bonding, ultrasonic welding, transmission laser welding, reverse conductive laser welding, light-absorbing dye laser welding and/or microwave welding.

One or more parts of the experimental component 106 may be coated on one or more surfaces with a barrier layer, such as Parylene, in order to render the bulk material biocompatible and/or non-cytotoxic. One or more parts of the experimental component 106 may be coated on one or more surfaces with a barrier layer, such as Parylene, in order to lower the water absorption of the bulk material, to lower the water vapour permeability of the bulk material, and to protect the bulk material from potential harmful interaction with fluid samples, chemicals, reagents and solvents. In some embodiments, the hydrophilicity of the microfluidic surfaces is improved by surface treatment techniques such as plasma polymerisation, UV treatment, saponification, poly-ethylene oxide grafting, surface texturing or electrowetting. In some embodiments, the non-specific binding of proteins or other biological material to the microfluidic surfaces is minimised by coating one or all surfaces with blocking agents such as acrylamides (AAm), polyethylene glycol (PEG), bovine serum albumin (BSA), egg albumin, whole serum, skim milk, salmon sperm DNA or herring sperm DNA.

Further information on appropriate materials and manufacturing techniques for the experimental component 106 may be found in the book entitled “Handbook of biosensors and biochips”, edited by R. S. Marks, D. Cullen, C. R. Lowe (Editor), H. H. Weetall and I. Karube, and published in October 2007 by John Wiley & Sons (ISBN: 978-0-470-01905-4), particularly in the Chapter entitled “Polymer-based Microsystem Techniques” by M. Schuenemann and E. C. Harvey. This Chapter is hereby incorporated by reference in its entirety herein.

### Example Optical Systems

In some embodiments, the instrumented pipette 100 and the experimental component 106 provide an optical system 1600A, 1600B, as shown in FIGS. 16A and 16B. The optical systems 1600A,1600B provide at least one optical emitter, at least one optical waveguide, and at least one detector. The emitter provides optical stimulation to at least part of a fluid sample in the experimental procedure, and the detector makes optical measurements of optical properties of fluids etc. in the experimental procedure.

The modular optical system 1600A includes an optical emitter 1602 and an optical detector 1604 in a pipette body 1606, as shown schematically in FIG. 16A. The optical emitter 1602 and the optical detector 1604 (e.g., a silicon photodiode) receive electrical power from electronic components embedded in the pipette body 1606. The optical emitter 1602 can be a light emitting diode (LED) light source, or a laser diode light source for emitting light at one or more selected wavelengths for stimulating a fluid sample 1608 held in a replaceable tip 1610. The replaceable 1610 is engaged with the experimental component 106, which is engaged with a pipette shaft 1612 of the pipette, as shown in FIG. 16A. Light passes from the optical emitter 1602 along one of two pipette waveguides 1614 in the pipette body 1606 and the pipette shaft 1612 to the experimental component 106. The optical signal from the optical emitter 1602 pass into one of a plurality of component waveguides 1616 in the experimental component 106 through one of a plurality of optical couplers 1618 which couple light between the pipette body 1606 and the experimental component 106. The pipette waveguides 1614 and component waveguides 1616 can be standard optical fibre components and the optical couplers 1618 can be standard optical couplers used in communications systems. The experiment chip 1620 is fastened to the body of the experimental component 106 using chip fasteners 1622, e.g., an adhesive such as epoxy resin, through or over which the component waveguides 1616 carry the optical signals.

The component waveguides 1616 guide the light from the optical emitter 1602 to an optical interaction region 1619 located on an experiment chip 1620 of the experimental component 106. The optical interaction region 1619 is a region or area of the experiment chip 1620 where light in the input component waveguide (of the component waveguides 1616) can interact with the fluid sample 1608. For example, the input component waveguide can have a cleaved end, and the light can be emitted from the input waveguide into the fluid sample 1608, e.g., for stimulating molecules or particles in the fluid sample 1608 to fluoresce based on properties of the molecules or particles. Optical signals from the optical interaction region 1619 are received or collected by an output component waveguide (of the component waveguides 1616) which guides the detected signals to the optical detector 1604 through a second one of the optical couplers 1618 and a second one of the pipette waveguides 1614.

In the integrated optical system 1600B, the experimental component 106 includes an on-chip emitter 1624 and an on-chip detector 1626 instead of the optical couplers 1618 for providing light to, and detecting light from, the optical interaction region 1619, as shown in FIG. 16B. In the integrated optical system 1600B, the pipette body 1606 can be from a standard commercially available pipette, i.e., without additional optical components in the pipette body 1606. The on-chip emitter 1624 can receive power from an electrical source, e.g., a battery in the experimental component 106, or from a wireless power receiver, such an inductive loop, in the experimental component 106.

The modular optical system 1600A and the integrated optical system 1600B can be used for conducting parts of experimental procedures relating to optical stimulation and detection, for example: luminescence measurements, fluorescence measurements, optical absorption measurements, turbidity measurements, refractive index measurements, etc.

FIGS. 16A and 16B show cross-sections of the pipette shaft 1612, the experimental component 106 and the tip 1610: these items are generally rotationally symmetrical around the central axis of the parts.

In some embodiments, the optical system in the instrumented pipette 100 and the experimental component 106 is provided by a combination of the modular optical system 1600A and the integrated optical system 1600B in which one of the optical emitter 1602 and the optical detector 1604 is in the pipette body 1606, and the other is in the experimental component 106. For example, the optical detector 1604 can be mounted in the pipette body 1606 for use with multiple different embodiments of the experimental component 106, each of which includes a different form of the optical emitter 1602, such as different coloured LED emitters intended for use in different luminescence measurements: different coloured LEDs are useful for measuring optical properties of different fluids, but the subsequently generated optical signals can all be detected by the same broad-band optical detector 1604, such as photo-detector that detects the intensity of received light over a broad range of colours.

In some further embodiments, the optical emitter 1602 and the optical detector 1604 can be integrated into the same side of the optical system such that only one of the pipette waveguides 1604 and one of the component waveguides 1616 is required to transmit light to and receive light from the optical interaction region 1619. For example, only the left-hand side waveguides 1614, 1616 as shown in FIGS. 16A and 16B may be required to guide light to and from the optical interaction region 1619. Use of a single waveguide is applicable for reflection measurements, whereas two waveguides are required for transmission measurements. In some further embodiments, the optical system can include both waveguides but still allow for both reflection and transmission measurements by receiving light from both waveguides that extend to the optical interaction region 1619.

### Example Ejector System

As mentioned hereinbefore with reference to FIGS. 8 to 11, in some embodiments the experimental component 106 includes an externally sliding member for transferring an ejecting force past the experimental component 106 to the disposable tip 104. In such an embodiment, as shown in FIGS. 17A to 17D, the experimental component 106 includes a component housing 1702 with a pipette interface configured to engage sealingly and separably with the pipette shaft 112, and a tip interface 1706 configured to engage sealingly and separably with a replaceable tip 1708 associated with the pipette shaft 112 (e.g., a commercially available tip sold in conjunction with the pipettes having the pipette shaft 112), as shown in FIG. 17A. The experimental component 106 includes a sliding member 1709, as shown in FIGS. 17A to 17D, which is slidingly attached to the component housing 1702 (e.g., having a longitudinal tongue that slides in grooves of the component housing 1702 between two stops in each groove, and encircles the circular component housing 1702) to slide relative to the component housing 1702.

As shown schematically in FIGS. 17A to 17D, the sliding member 1709 is configured to receive an ejecting force applied by an ejector member 1710 of the pipette (e.g., a sheath ejector actuated by a button on the pipette body 102 that can be depressed to eject normal disposable tips by the operator, and returns to its upper rest position by action of a spring in the pipette body 102).

In an installed condition 1700A, as shown in FIG. 17A, the experimental component 106 is fitted to the pipette shaft 112, the replaceable tip 1708 is fitted to the experimental component 106, and a fluid sample 1712 is held in the replaceable tip 1708 (by vacuum pressure applied by the pipette body 102). With the instrumented pipette 100 in the installed condition 1700A, an experiment chip 1714, attached to the component housing 1702 by fasteners or attachors 1716, can perform at least part of the experimental procedure on the fluid sample 1712.

From the installed condition 1700A, the operator can operate the pipette body 102 to move the ejector member 1710 relative to the pipette shaft 112 and towards the component housing (generally affixed to the pipette shaft 112). The sliding member 1709 has upper bearing surfaces 1718 which receive an ejecting force or loading applied by the ejector member 1710 and thus slide relative to the fixed component housing 1702 to apply an ejecting force or loading to the replaceable tip 1708, to move the replaceable tip 1708 from the tip interface 1706. By moving the ejector member 1710 a sufficient distance, corresponding to the axial length of the tip interface 1706, the replaceable tip 1708 is moved, dislodged, or ejected from the experimental component 106, thus moving the instrumented pipette 100 to a tip-ejected condition 1700B, as shown in FIG. 17B. The component housing 1702 remains attached to the pipette shaft 112 by the pipette interface 1704 when the instrumented pipette 100 is in the tip-ejected condition 1700B.

To eject or remove the experimental component 106 from the pipette shaft 112, the operator can move the ejector member 1710 an additional distance along the pipette shaft 112 to engage upper bearing surfaces 1720 of the component housing 1702, and to apply an ejecting force to the component housing 1702. When the ejector member 1710 has pushed the component housing 1702 an axial distance along a pipette shaft 112 equal to or greater than the axial length of the pipette interface 1704, the experimental component 106 is no longer engaged or attached to the pipette shaft 112, and the instrumented pipette 100 moves to a component-ejected condition 1700C, as shown in FIG. 17C.

Once both the replaceable tip 1708 and the experimental component 106 have been ejected from the pipette body 102, the different parts of the instrumented pipette 100 are in a separated condition 1700D, as shown in FIG. 17D. The replaceable tip 1708 is a form of the disposable tip 104.

An embodiment of the experimental component 106 including the sliding member 1709 can be engaged with the pipette body 102 by fitting the experimental component 106 to the pipette shaft 112 by pushing the pipette shaft 112 into the component housing 1702 to engage the pipette interface 1704. The pipette interface 1704 can be provided by an elastic component of the component housing 1702 that stretches to fit around the pipette shaft 112 and to provide an interference fit between the pipette body 102 and the experimental component 106. The interference fit is generally fluid-impervious so that any vacuum or air pressure applied through operation of the pipette body 102 is applied through the component housing 1702. The replaceable tip 1708 or the disposable tip 104 (or one of any number of these formed as commercially available disposable tips) are fitted to the experimental component 106 by forcing the component housing 1702 into the upper part of the tip 104,1708, such that the tip interface 1706 fits into the upper aperture of the tip 104, 1708, which includes some elasticity to expand around the lower part of the component housing 1702, and thus provide a generally fluid-impervious interference fit for holding the tip 104, 1708 to the component housing 1702 and for conducting any air pressure or vacuum through tip interface 1706 to the tip itself 104, 1708, for normal suction and dispensing of fluids into and from the tip 104,1708.

FIGS. 17A to 17D show cross-sections of the pipette shaft 112, the experimental component 106 and the tip 1708: these items are generally rotationally symmetrical around the central axis of the parts, which is the common central axis of the parts in the installed condition 1700A.

### Example Using Standard Pipettes

In some embodiments, the experimental component 106 is configured to attach to standard commercially available pipettes. Having the experimental component 106 configured in this way can allow an operator to use their existing laboratory pipette equipment, e.g., including calibrated micropipettes and supplies of associated disposable tips (which can be specifically selected for certain types of experiments and fields of expertise), to perform the experimental procedures associated with the experimental component 106. The operators can thus be familiar with the equipment, and there may be no need to purchase additional expensive pipetting hardware and disposables. For example, the volumes of the pipettes in a lab are related to the type of work being done, and the materials and/or coatings of the disposable tips may be selected based on the types of samples being studied, etc.: thus using parts of the pre-existing commercially available pipetting equipment in a lab may be useful to an operator.

The attachment to a standard commercially available pipette is sufficiently tight to ensure mechanical stability of the component 106 on the standard pipette, at least due to gravity and during movement of the standard pipette, thus the component 106 stays attached to the standard pipette as it is moved by an operator (which can be a person or a robot). The attachment mechanism can be equivalent to that of a removable tip attaching to the standard pipette: a slight elasticity of the pipette interface of the component 106—that is slightly smaller in inner diameter than the outer diameter of the distal end of the shaft of the standard pipette—allows it to fit tightly (forming an interference fit) over the distal end of the shaft and hold on to the pipette body. This attachment is also generally impervious to fluid so any pressure generated by operation of the standard pipette is also exerted through the component 106, e.g., to draw in or expel the fluid sample, and so no liquid can leak from the seal, e.g., to avoid contamination or sample loss.

Example commercially available pipettes and replaceable tips include “Eppendorf” brand pipette equipment available from Eppendorf A. G. Example pipette sizes, with corresponding pipette and tip dimensions, including: 0.1-2.5 microlitres (uL), 0.5-10 uL, 2-20 uL, 20-200 umL, 100-1,000 uL, and 1,000-5,000 uL.

### Example Near-Field Wireless System

The wireless transceiver 1202, in the experimental component 106, and the wireless receiver 208, in the external experimental unit 1302, can form a near-field communication (NFC) wireless system based on RFID technology. The wireless system uses magnetic induction to allow communication and power transfer between the transceiver 1202 and the receiver 208 when in close proximity, and relies on standard protocols for secure data transfer. An example wireless system operates in the standard unlicensed 13.56 MHz frequency band over a distance of up to around 20 centimetres, and can have a data transfer rate of about 106 kbit/s, 212 kbit/s or 424 kbit/s. The wireless transceiver 1202 can be in the form of an NFC tag (or RFID tag) including a radio-frequency (RF) antenna, and the wireless receiver 208 can include a form of NFC or RFID reader. An example NFC tag can include a Philips PN 531 integrated circuit (IC). The 531 IC includes a Smart Transmission Module that can act as a sender or receiver. The 531 IC includes a 80C51 microcontroller, with 32 kbyte ROM, 1 k byte RAM, and embedded firmware to support the ISO 14443A and FeliCa protocols. The 531 IC and similar chips can include an analog front end to drive the antenna of the NFC tag.

Embodiments of the wireless transceiver 1202, formed in accordance with RFID tag architectures, can include:
(a) an antenna directly matched to the RFID tag's front end, impedance to communicate with the NFC or RFID reader;
(b) an analogue RF front end with rectifier circuitry to convert received RF electrical power, received from a wireless power transmitter of the RFID reader, into direct current (DC), a clock, a modulator and a demodulator;
(c) a logic part to translate between the front end and the sensor interface by coding, decoding, commanding, processing, and storing information, in accordance with a commercially available defined standard and associated protocol; and
(d) a signal interface module that adapts the externally received signals (e.g., sensor readings from the sensors, including the measurement signals, and data logging signals) to a standardized RFID tag.

The signal interface module can be a bus interface (e.g., Serial Peripheral Interface, SPI, or Inter Integrated Circuit, I2C) to connect directly the logical part of the RFID tag to an additional block such as the measurement sensors, and the RFID sensor tag can be either semi-passive or active. Alternatively, the signal interface can be a sensor interface that sensor readout circuitry (including a charge amplifier, a resistive bridge, etc.) and an analogue to digital converter (ADC) to convert the change of value of a sensor to a digital signal. The sensor interface can either be passive (where the readout electronics and the analogue to digital converter are fully powered by the electromagnetic power received from the RFID reader) or semipassive (where an additional battery in the experimental component 106 powers up the interface as well as the logic). Example ADCs that are suitable for the low-power environment on the experimental component 106 include ADCs using successive approximation registers (SARs), e.g., National Instrument's ADC121S101, that can be connected to the sensor elements via analog signal conditioning circuits.

### Interpretation

Many further modifications to the embodiments herein described with reference to the accompany drawings will be apparent to those skilled in the art without departing from the scope of the present invention.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### Basic Application

The disclosure of the following related basic application is hereby incorporated by reference herein: U.S. Provisional Patent Application No. 61/243,904, filed on 18 Sep. 2009, entitled “Instrumented Pipette”.

REFERENCE SIGNS

| Ref. | Associated Term |
|---|---|
| 100 | instrumented pipette |
| 102 | pipette body |
| 104 | disposable tip |
| 106 | experimental component |
| 108 | pipette handle |
| 110 | plunger |
| 112 | pipette shaft |
| 114 | shaft tip |
| 116 | pipette display |
| 118 | integrated electronics region |
| 200 | pipette system |
| 202 | base station |
| 204 | external device |
| 206 | pipette stand |
| 208 | wireless receiver |
| 210 | external display |
| 212 | user input controls |
| 214 | display connector |
| 300 | integrated electronic units |
| 302 | wireless transceiver unit |
| 304 | electrode interface unit |
| 306 | signal conductors |
| 308 | plunger mechanism |
| 402 | interface portion |
| 404 | chip portion |
| 406 | upper channel |
| 408 | on-chip signal conductors |
| 412 | fluid chamber |
| 414 | micro channel |
| 416 | seal |
| 600 | simple experimental method |
| 700 | general experimental method |
| 802 | tip eject actuator |
| 804 | component eject actuator |
| 900 | assembled state |
| 1000 | tip ejected state |
| 1002 | example tip interface |
| 1100 | experimental component ejected |
| | state |
| 1202 | wireless transceiver |
| 1302 | external experimental unit |
| 1304 | recess |
| 1305 | external display unit |
| 1400 | c-ELISA chip |
| 1402 | serpentine channel |
| 1404 | sensor chamber |
| 1406 | sensor electrode |
| 1407 | reference electrode |
| 1408 | conditioning electronics |
| 1410 | transceiver electronic circuit |
| 1412 | capture antibodies |
| 1414 | lyophilised complex |
| 1500 | s-ELISA chip |
| 1502 | sensor chamber |
| 1504 | sensor electrode |
| 1505 | reference electrode |
| 1506 | conditioning electronics |
| 1508 | transceiver electronic circuit |
| 1510 | primary PSA antibodies |
| 1602 | optical emitter |
| 1604 | optical detector |
| 1606 | pipette body |
| 1608 | fluid sample |
| 1610 | replaceable tip |
| 1612 | pipette shaft |
| 1614 | pipette waveguides |
| 1616 | component waveguides |
| 1618 | optical couplers |
| 1619 | optical interaction region |
| 1620 | experiment chip |
| 1622 | chip fasteners |
| 1624 | on-chip emitter |
| 1626 | on-chip detector |
| 1702 | component housing |
| 1704 | pipette interface |
| 1706 | tip interface |
| 1708 | replaceable tip |
| 1709 | sliding member |
| 1710 | ejector member |
| 1712 | fluid sample |
| 1714 | experiment chip |
| 1716 | attachors |
| 1718 | bearing surfaces |
| 1720 | bearing surfaces |

1.-30. (canceled)

31. A pipette component for use in performing an experimental procedure with a fluid sample and a pipette, the pipette component including:
a pipette interface configured to engage sealingly and separably with a body of the pipette;
a tip interface configured to engage sealingly and separably with a replaceable tip; and
an experiment region configured to receive at least part of the fluid sample by operation of the pipette, and configured to perform at least part of the experimental procedure in the experiment region using the at least part of the fluid sample.

32. The pipette component of claim 31, wherein the pipette interface includes a generally circular socket including elastic material configured to engage around a distal end of a shaft of the body of the pipette.

33. The pipette component of claim 31, including a bearing surface configured to receive an ejecting force applied by an ejector of the pipette to eject the pipette component from the pipette; optionally the pipette component including: a housing with the pipette interface and the tip interface; and a sliding member, slidingly attached to the housing to slide relative to the housing, and configured to receive an ejecting force applied by an ejector of the pipette to eject the replaceable tip from the pipette component.

34. The pipette component of claim 31, wherein the experiment region includes at least one microfluidic structure configured to perform at least part of the experimental procedure; optionally wherein the experiment region includes a chamber configured to receive and hold at least part of the fluid sample in part of the experimental procedure.

35. The pipette component of claim 31, including a stored substance for use in the experimental procedure; optionally wherein the experiment region includes a fluidic mixing structure configured to cause at least part of the fluid sample to mix with the stored substance in the experimental procedure.

36. The pipette component of claim 31, including a seal covering an opening of the pipette component for substantially sealing an interior of the pipette component from its environment.

37. The pipette component of claim 31, wherein the experiment region includes at least one sensor configured to generate measurement signals by measuring a sample property in the experimental procedure; optionally wherein the at least one sensor is electrical, electrochemical and/or optical for measuring at least one respective electrical, electrochemical and/or optical property of the at least part of the fluid sample in the experimental procedure.

38. The pipette component of claim 37, including a transmitter configured to receive the measurement signals, and to transmit corresponding signals to an external receiver system.

39. The pipette component of claim 31, wherein the pipette is a standard commercially available pipette; optionally wherein the pipette is a handheld manually operated pipette; optionally wherein the pipette is a machine-operated robotic pipette.

40. An instrumented pipette including the pipette component of claim 31.

41. The instrumented pipette of claim 40, including a plunger for controlling air pressure to draw in and dispense the part of the fluid sample; optionally including one or more ejectors for ejecting the replaceable tip and/or the pipette component.

42. A pipette system including the pipette component of claim 31, and an external unit with at least one of: a wireless power transmitter for transmitting power wirelessly to the experimental component; an antenna for receiving measurement signals wirelessly from the experimental component; and an optical detector for receiving optical signals from the experimental component.

43. A method of performing an experimental procedure with a fluid sample and a pipette including:
fitting a pipette component to the pipette;
fitting a replaceable tip to the pipette component;
drawing at least part of the fluid sample into contact with the pipette component by operating the pipette; and
performing at least part of the experimental procedure in the pipette component using the at least part of the fluid sample.

44. The method of claim 43, including:
ejecting the replaceable tip from the pipette component by operating the pipette;
fitting a further replaceable tip to the pipette component;
drawing a further fluid sample into the pipette component by operating the pipette; and
performing a further part of the experimental procedure in the pipette component using the further fluid sample;
the method optionally including: ejecting the pipette component from the pipette by operating the pipette;
the method optionally including: performing at least part of the experimental procedure in one or more microfluidic structures of the pipette component;
the method optionally including: performing at least part of the experimental procedure using at least one stored substance in the pipette component.

45. A pipette component for use in performing an experimental procedure with a fluid sample and a pipette, the pipette component including:
a pipette interface configured to engage sealingly and separably with a body of the pipette;
a stored substance for use in the experimental procedure; and an experiment region configured to receive at least part of the fluid sample by operation of the pipette, and configured to perform at least part of the experimental procedure in the experiment region using the stored substance and the fluid sample.

46. A method of performing an experimental procedure with a fluid sample and a pipette including:
fitting a pipette component to the pipette;
drawing at least part of the fluid sample into contact with the pipette component by operating the pipette; and
performing at least part of the experimental procedure using at least one stored substance in the pipette component and the at least part of the fluid sample.

47. A pipette component for use in performing an experimental procedure with a fluid sample and a pipette, the pipette component including:
a pipette interface configured to engage sealingly and separably with a body of the pipette;
an experiment region configured to receive at least part of the fluid sample by operation of the pipette, and configured to perform at least part of the experimental procedure in the experiment region using the at least part of the fluid sample to generate one or more measurement signals; and
a transmitter configured to receive the measurement signals, and to transmit corresponding signals to an external receiver system.

48. A method of performing an experimental procedure with a fluid sample and a pipette including:
fitting a pipette component to the pipette;
drawing at least part of the fluid sample into the pipette component by operating the pipette;
performing at least part of the experimental procedure using at least part of the fluid sample in the pipette component, including generating one or more measurement signals by measuring a sample property in the experimental procedure; and
transmitting signals, corresponding to the measurement signals, to an external receiver system using a transmitter in the experimental component.

49. A pipette adapter including:
a pipette interface portion configured to fit sealingly and separably to a pipette;
a tip interface portion configured to receive a replaceable tip; and
an experiment portion configured to receive at least a part of the fluid sample drawn through the replaceable tip by operation of the pipette.

50. A pipette component including:
a pipette interface configured to engage sealingly and separably with a pipette;
a tip interface configured to engage sealingly and separably with a replaceable tip; and
an experiment portion configured to perform at least part of an experimental procedure by interacting with at least a part of a fluid sample in contact with the experiment portion and drawn into the replaceable tip by the pipette.
